(19) United States
(12) Patent Application Publication
(10) Pub. No.: US 2016/0335886 A1
(43) Pub. Date: Nov. 17, 2016

(54) Wireless Alarm System

(71) Applicant: Electronics Tomorrow Limited, Hong Kong (HK)

(72) Inventor: Andrew Yick Siu WEI, Hong Kong (HK)

(73) Assignee: Electronics Tomorrow Limited

(21) Appl. No.: 14/709,256

(22) Filed: May 11, 2015

(51) Int. Cl. G08C 17/02; H04W 4/00

(52) U.S. Cl. CPC G08C 17/02; H04W 4/008

(57) ABSTRACT

A wireless alarm system includes an alarm station and a mobile control device. The alarm station includes an alarm casing, a first wireless transceiver, an alarm device, and a first processing module supported in the alarm casing and electrically connected to the first wireless transceiver and the alarm device. The mobile control device includes a mobile device casing, a control panel, a second wireless transceiver wirelessly communicated with the first wireless transceiver of the alarm station, and a second processing module electrically connected to the control panel and the second wireless transceiver. The second processing module is configured to wirelessly communicate with the first processing module for setting up an alarm in the alarm station, so that a user is able to control setting of time and alarm in the alarm station by operating on the mobile control device.

### BACKGROUND OF THE PRESENT INVENTION

1. Field of Invention

The present invention relates to an alarm system, and more particularly to a wireless alarm system which may be controlled and set up by a mobile control device through wireless technology.

2. Description of Related Arts

A conventional alarm timepiece such as an alarm clock usually comprises a main timepiece assembly, an alarm signal generator such as a speaker provided on the main timepiece assembly, and an input mechanism provided on the main timepiece assembly for allowing a user to input a predetermined time so that when the predetermined time has reached, the alarm signal generator will be triggered for generating alarm signals.

A main disadvantage of the conventional alarm timepiece is that the alarm time must be inputted by the input mechanism provided on the main timepiece assembly. This is true irrespective of whether the alarm timepiece is analog or digital. A user who wishes to set an alarm must have physical access to the relevant alarm timepiece and operate the corresponding input mechanism. When the alarm timepiece is positioned at a distance from the user, an alarm cannot be properly set.

This situation gets worse when a user wishes to set many different alarms. In this scenario, the user has to access the many different alarm timepieces one by one and operate the corresponding input mechanism. This practice is very time-consuming and inconvenient. Therefore, there is a need for a wirelessly controlled and monitored alarm timepiece.

### SUMMARY OF THE PRESENT INVENTION

An objective of the present invention is to provide a wireless alarm system which may be controlled and monitored by a mobile control device through wireless technology.

Another objective of the present invention is to provide a wireless alarm system which may acquire time and location information through a specifically programmed mobile device.

Another objective of the present invention is to provide a wireless alarm system comprising a mobile control device and a plurality of alarm stations, wherein the mobile control device is capable of centrally controlling and monitoring the alarm stations in a wireless manner.

In one aspect of the present invention, it provides a wireless alarm system, comprising:

at least one alarm station, which comprises:

an alarm casing;

a first wireless transceiver provided in the alarm casing;

an alarm device;

a first processing module supported in the alarm casing and electrically connected to the first wireless transceiver and the alarm device; and

a mobile control device which is connected to internet, and comprises:

a mobile device casing;

a control panel supported on the device casing;

a second wireless transceiver supported by the mobile device casing, and wirelessly communicated with the first wireless transceiver of the alarm station; and

a second processing module supported in the mobile device casing and electrically connected to the control panel, and the second wireless transceiver, the second processing module being configured to communicate with the first processing module via the first wireless transceiver and the second wireless transceiver for setting up an alarm in the alarm station, whereby a user is able to control setting of time and alarm in the alarm station by operating on the control panel of the mobile control device.

In another aspect of the present invention, it provides an alarm station for use with a mobile control device, comprising:

an alarm casing;

a first wireless transceiver provided in the alarm casing;

an alarm device; and

a first processing module supported in the alarm casing and electrically connected to the first wireless transceiver and the alarm device, the first processing module being configured to receive wireless signals from the mobile control device through the first wireless transceiver, and drive the alarm device to generate an alarm signal in accordance with the signals of the mobile control device, whereby a user is able to control setting of the alarm in the alarm station by operating on the mobile control device.

### BRIEF DESCRIPTION OF THE DRAWINGS

FIG. 1 is a perspective view of a wireless alarm system according to a preferred embodiment of the present invention.

FIG. 2 is an exploded perspective view of an alarm station of the wireless alarm system according to the preferred embodiment of the present invention.

FIG. 3 is a sectional side view of an alarm station of the wireless alarm system according to the preferred embodiment of the present invention.

FIG. 4 is a block diagram of the wireless alarm system according to the preferred embodiment of the present invention.

FIG. 5 is a flow diagram of the operation of the mobile control device and the alarm station according to the preferred embodiment of the present invention.

FIG. 6 illustrates an operation of the mobile control device which is utilized to set an alarm time for the corresponding alarm station according to the preferred embodiment of the present invention.

FIG. 7 illustrates an operation of the mobile control device which is utilized to set a timer for the corresponding alarm station according to the preferred embodiment of the present invention.

FIG. 8A to FIG. 8E are circuit diagrams of the wireless alarm system according to the preferred embodiment of the present invention.

FIG. 9 is a perspective view of a wireless alarm system according to a first alternative mode of the preferred embodiment of the present invention.

FIG. 10 is an exploded perspective view of an alarm station of the wireless alarm system according to the first alternative mode of the preferred embodiment of the present invention.

FIG. 11 is a sectional side view of an alarm station of the wireless alarm system according to the first alternative mode of the preferred embodiment of the present invention.

FIG. 12 is a block diagram of the wireless alarm system according to the first alternative mode of the preferred embodiment of the present invention.

FIG. 13 is a flow diagram of the operation of the mobile control device and the alarm station according to the first alternative mode of the preferred embodiment of the present invention.

FIG. 14 illustrates an operation of the mobile control device which is utilized to set an alarm time for the corresponding alarm station according to the first alternative mode of the preferred embodiment of the present invention.

FIG. 15 illustrates an operation of the mobile control device which is utilized to set a timer for the corresponding alarm station according to the first alternative mode of the preferred embodiment of the present invention.

FIG. 16A to FIG. 16D are circuit diagrams of the wireless alarm system according to the first alternative mode of the preferred embodiment of the present invention.

FIG. 17 is a perspective view of a wireless alarm system according to a second alternative mode of the preferred embodiment of the present invention.

FIG. 18 is an exploded perspective view of an alarm station of the wireless alarm system according to the first alternative mode of the preferred embodiment of the present invention.

FIG. 19 is a side view of an alarm station of the wireless alarm system according to the second alternative mode of the preferred embodiment of the present invention.

FIG. 20 is a block diagram of the wireless alarm system according to the second alternative mode of the preferred embodiment of the present invention.

FIG. 21 is a flow diagram of the operation of the mobile control device and the alarm station according to the second alternative mode of the preferred embodiment of the present invention.

FIG. 22 illustrates an operation of the mobile control device which is utilized to set an alarm time for the corresponding alarm station according to the second alternative mode of the preferred embodiment of the present invention.

FIG. 23 illustrates an operation of the mobile control device which is utilized to set a timer for the corresponding alarm station according to the second alternative mode of the preferred embodiment of the present invention.

FIG. 24 is a schematic diagram of a wireless alarm system according to a second alternative mode of the preferred embodiment of the present invention, illustrating that the alarm station may be configured as a wall clock.

FIG. 25A to FIG. 25C are circuit diagrams of the wireless alarm system according to the second alternative mode of the preferred embodiment of the present invention.

FIG. 26A to FIG. 26E are circuit diagrams of the wireless alarm system according to the second alternative mode of the preferred embodiment of the present invention when the wireless alarm system is mounted on a wall surface.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

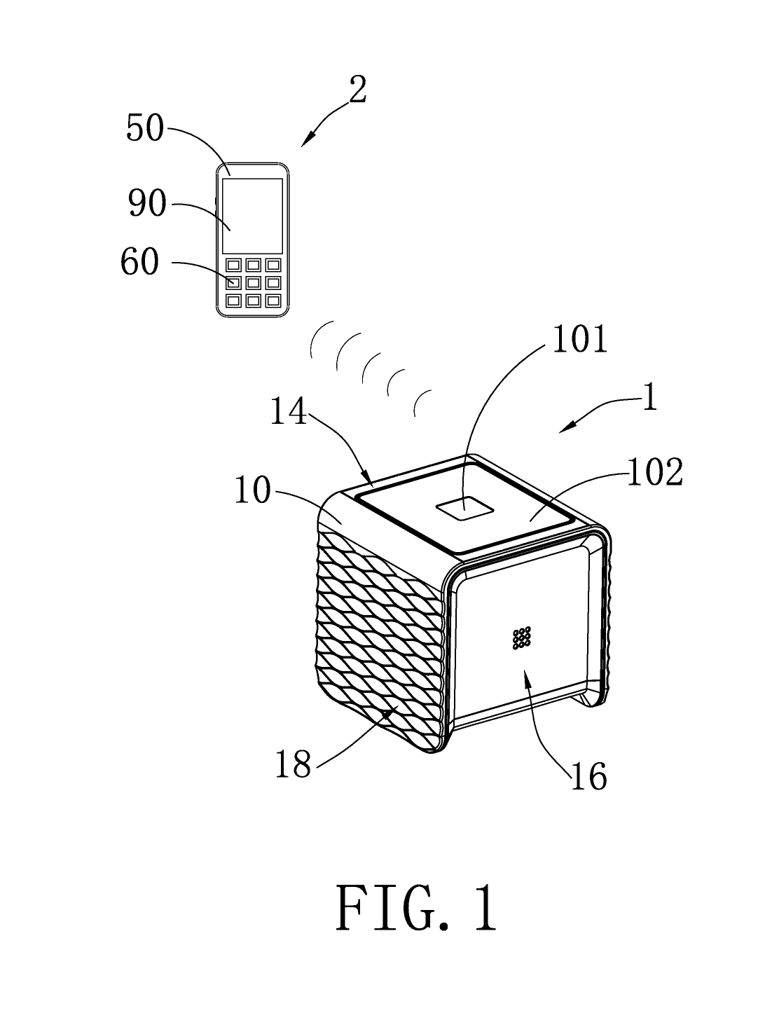

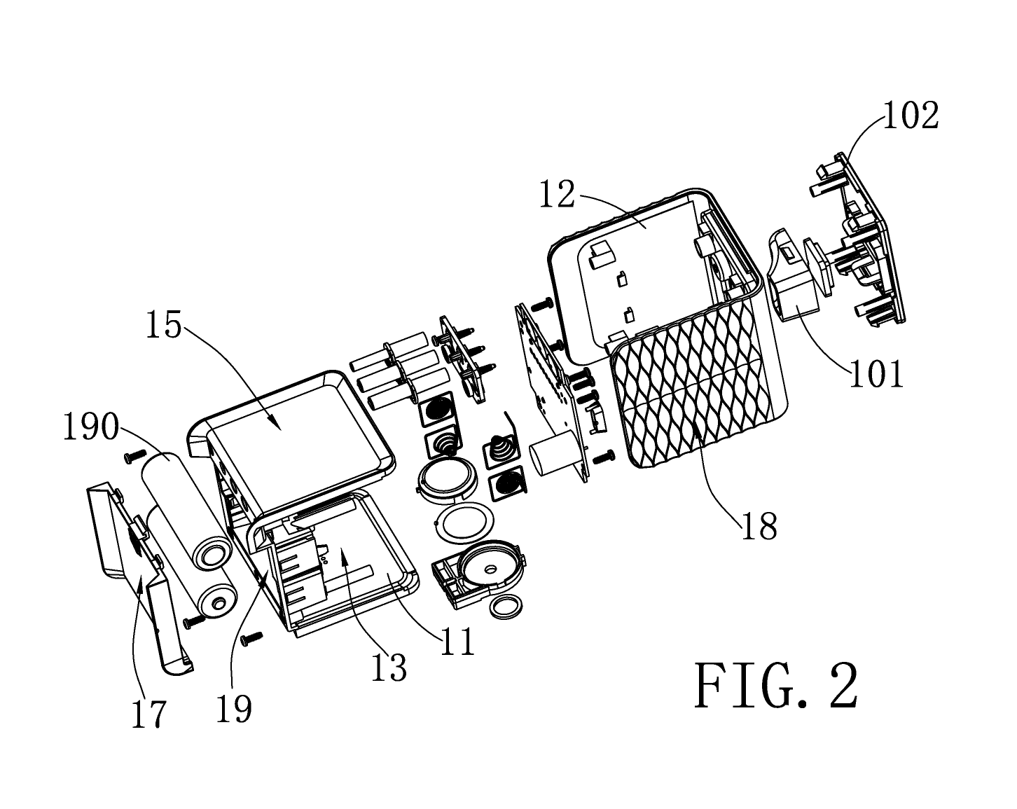

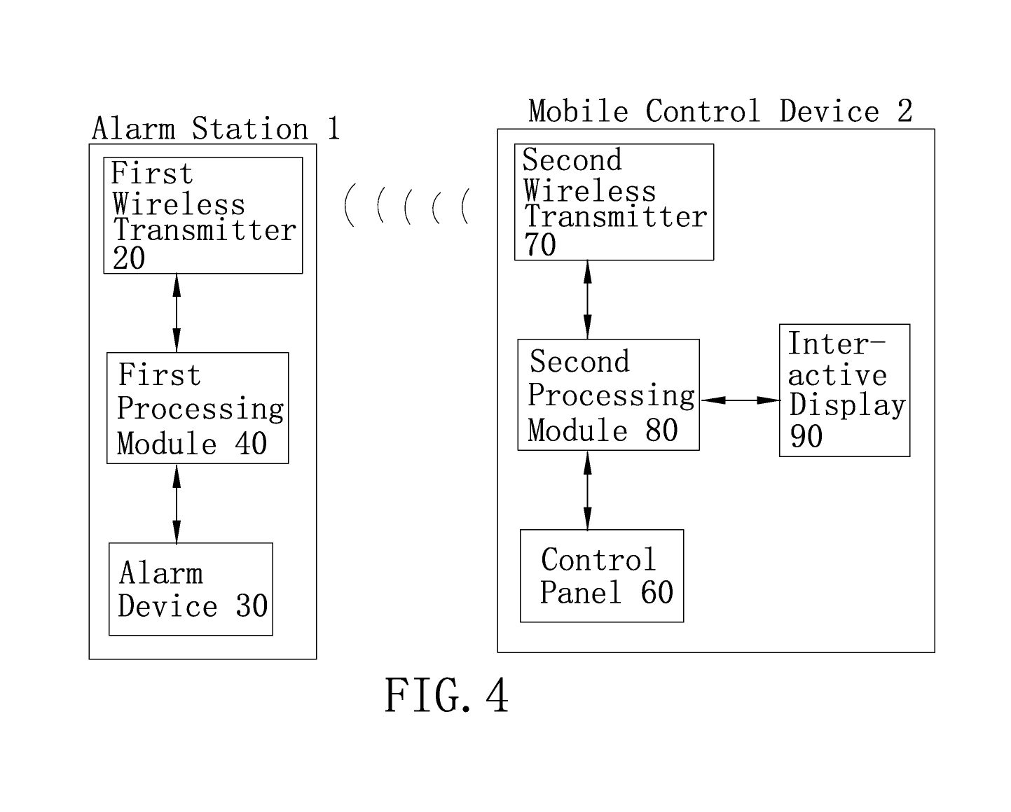

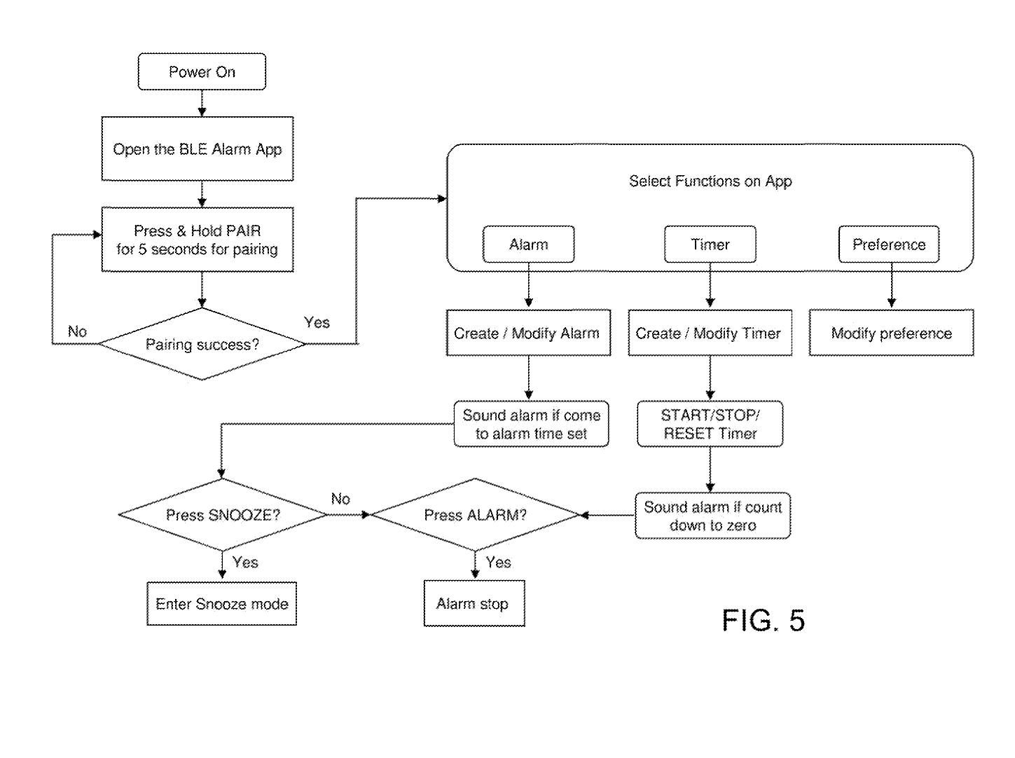

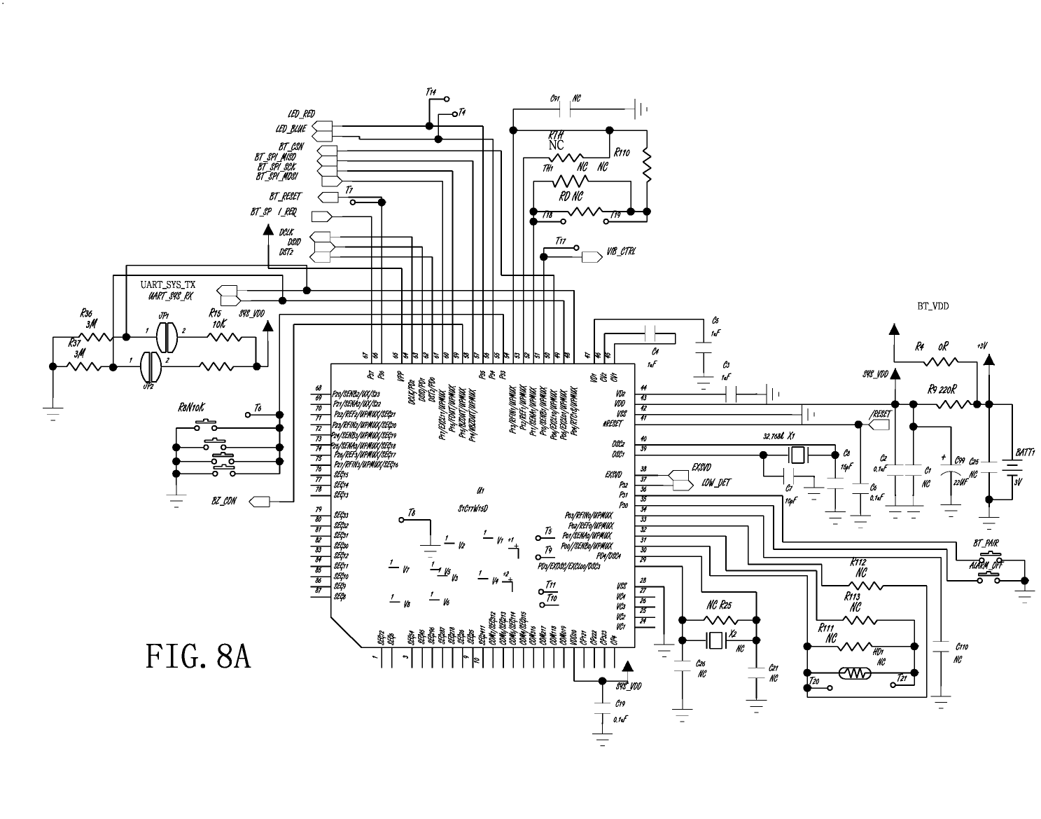

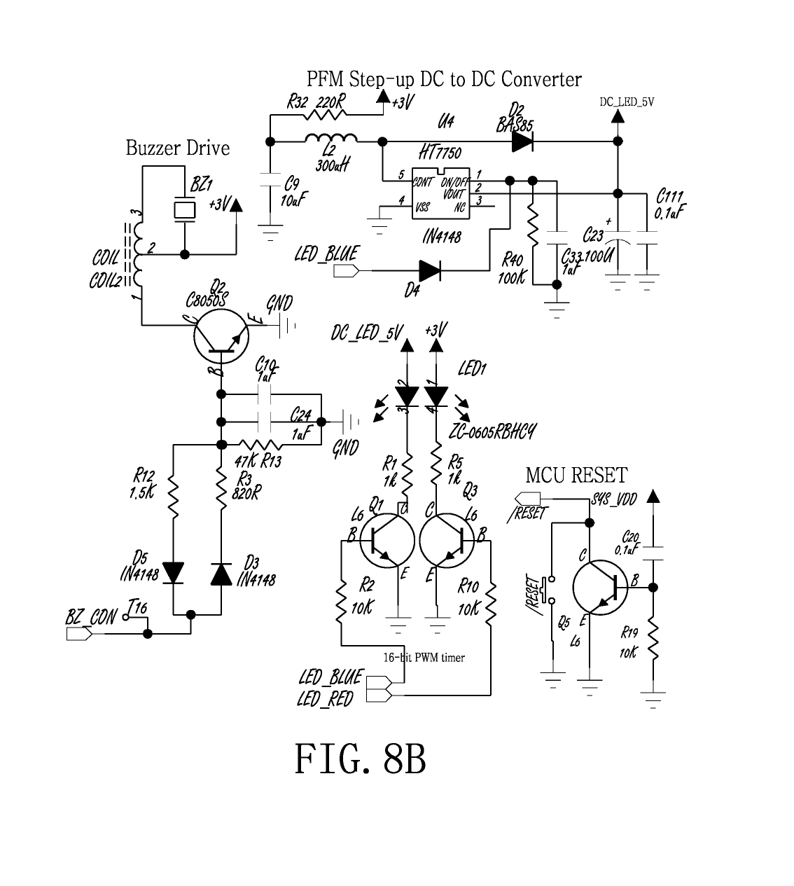

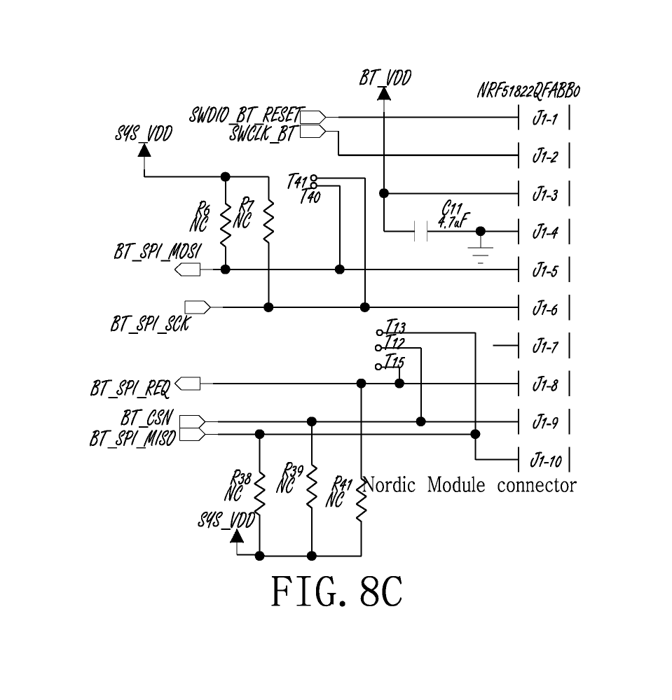

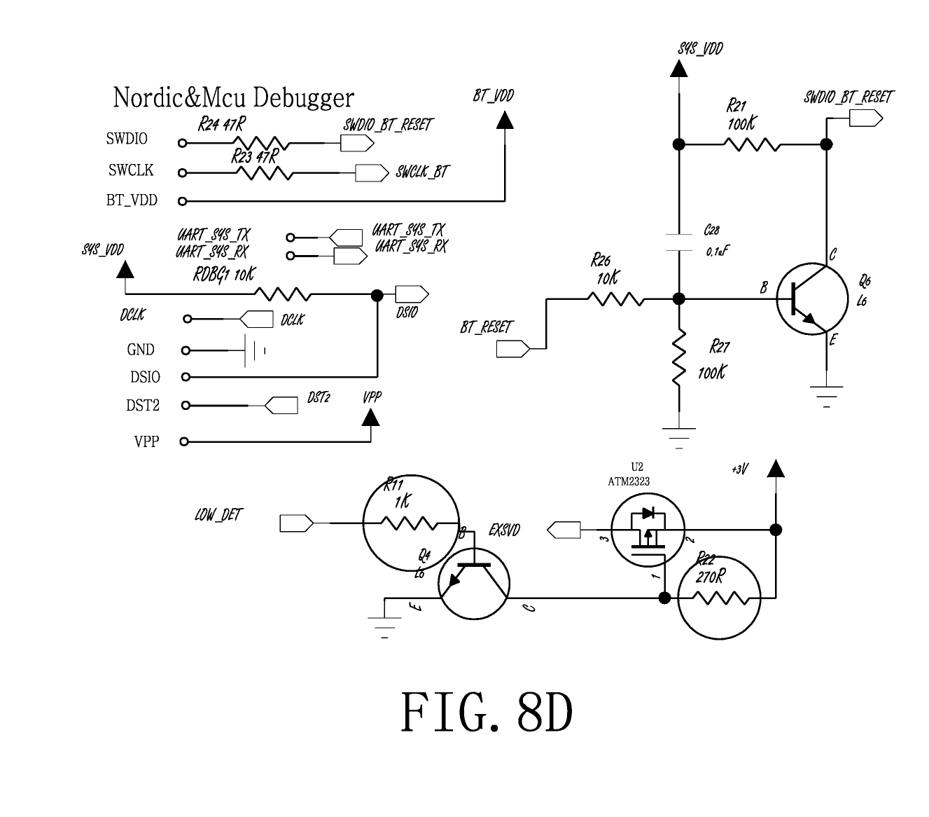

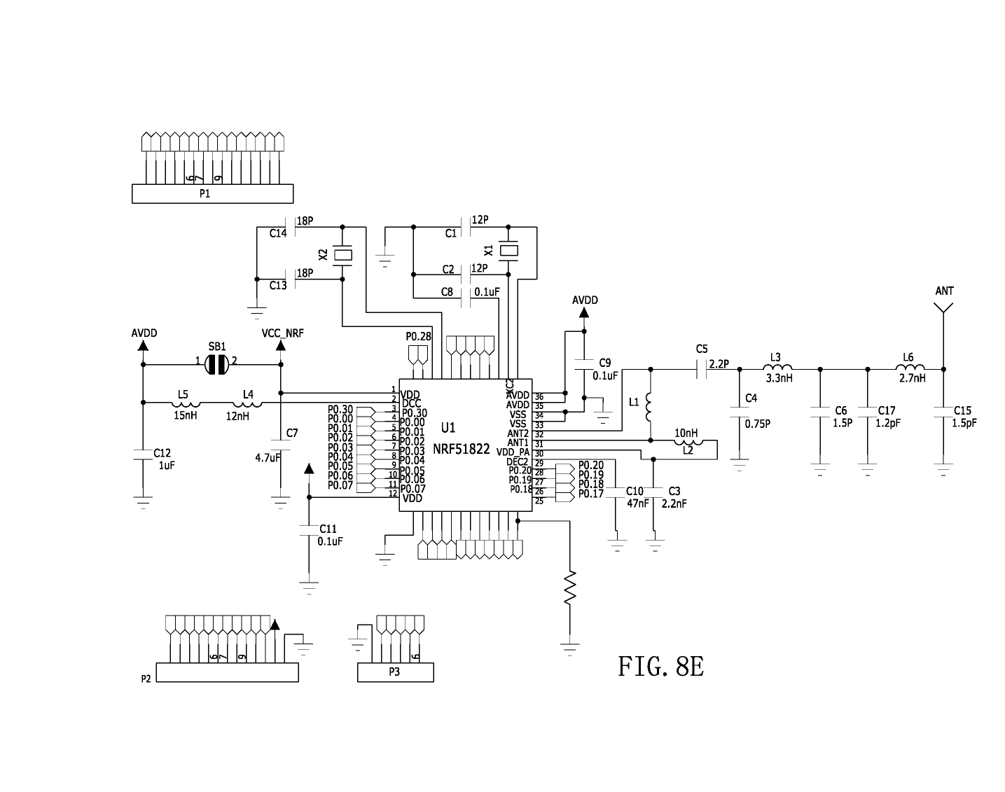

Referring to FIG. 1 to FIG. 7, and FIG. 8A to FIG. 8D of the drawings, a wireless alarm system according to a preferred embodiment of the present invention is illustrated.

Broadly, the wireless alarm system comprises at least one alarm station 1, and a mobile control device 2 wirelessly communicating with the alarm station 1.

The alarm station 1 comprises an alarm casing 10, a first wireless transceiver 20 provided in the alarm casing 10, an alarm device 30 supported in the alarm casing 10, and a first processing module 40.

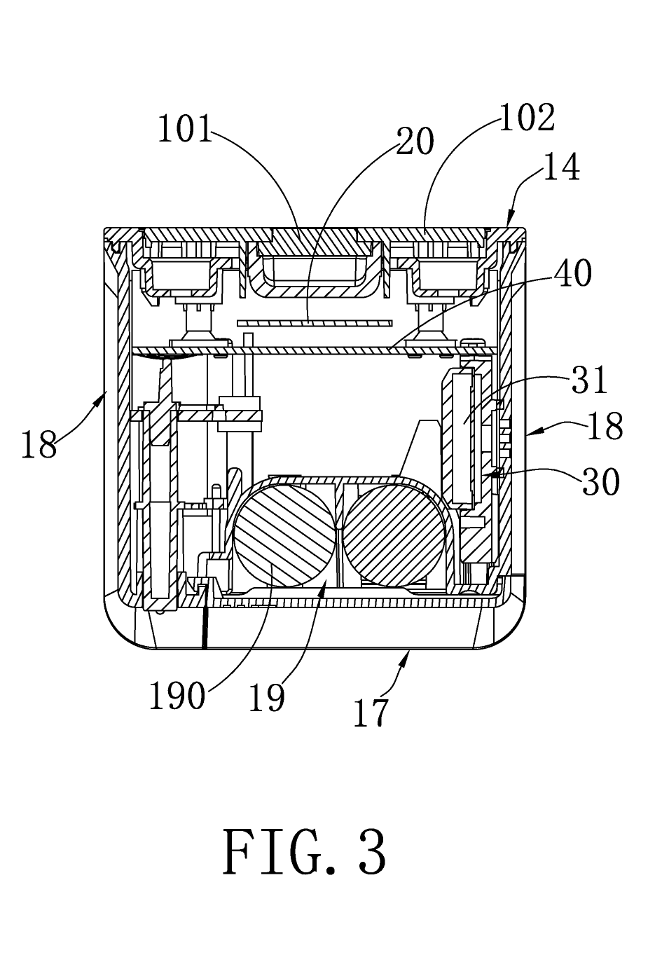

The first processing module 40 is supported in the alarm casing 10 and is electrically connected to the first wireless transceiver 20 and the alarm device 30. Preferably, the first processing module 40 is implemented in a Printed Circuit Board (PCB) as shown in FIG. 3 of the drawings.

The mobile control device 2 is connected to a telecommunication network or internet, and comprises a mobile device casing 50, a control panel 60 supported on the mobile device casing 50, and a second wireless transceiver 70 supported by the mobile device casing 50, and wirelessly communicated with the first wireless transceiver 20 of the alarm station 1.

The mobile control device 2 further comprises a second processing module 80 supported in the mobile device casing 50 and electrically connected to the control panel 60 and the second wireless transceiver 70. The second processing module 80 is configured to communicate with the first processing module 40 via the first wireless transceiver 20 and the second wireless transceiver 70 for setting up an alarm or a timer in the alarm station 1, whereby a user is able to control setting of time and alarm in the alarm station 1 by operating on the control panel 60 of the mobile control device 2.

According to the preferred embodiment of the present invention, the alarm casing 10 is configured to rest or stand on a flat surface. As shown in FIG. 1 to FIG. 3 of the drawings, the alarm casing 10 in this preferred embodiment may comprise a first casing member 11 and a second casing member 12 attached on the first casing member 11 to define a receiving cavity 13 in the alarm casing 10. The alarm casing 10 has a substantially cubic structure having a top surface 14, a front surface 15, a rear surface 16, a bottom surface 17 and two side surfaces 18.

Furthermore, the alarm casing 10 further has a battery compartment 19 for accommodating a predetermined number of batteries 190. The batteries can be typical AA or AAA sized batteries, and they may be rechargeable. The batteries supply power to other parts of the alarm station 1, such as the first wireless transceiver 20, the alarm device 30 and the first processing module 40.

The first wireless transceiver 20 is supported in the receiving cavity 13 for wirelessly connecting with the second wireless transceiver 70 of the mobile control device 2. In this first preferred embodiment, the wireless communication between the first wireless transceiver 20 and the second wireless transceiver 70 may be accomplished by BLUETOOTH 4.0 low energy connectivity technology. Thus, the first wireless transceiver 20 and the second wireless transceiver 70 are BLUETOOTH communication modules.

The alarm device 30 comprises at least one speaker unit 31 supported in the receiving cavity 13 for generating audible signals as alarm signals. The audible signals can be in the form of music.

The first processing module 40 controls the operation of other components of the alarm station 1, and processes the signals or commands received by the first wireless transceiver 20. The time at which the alarm is triggered or activated is controlled and set by the mobile control device 2, in which commands or control signals are wirelessly transmitted from the mobile control device 2 to the first processing module 40 through the first wireless transceiver 20. Thus, the first processing module 40 is implemented with an electronic timer as an internal clock so that the first processing module 40 keeps timing information.

The alarm station 1 further comprises an illuminating device 101 and a control button 102 provided on the alarm casing 10, and are electrically connected to the first processing module 40. The illuminating device 101 is arranged to generate illumination of different colors for indicating different operation statuses of the alarm station 1. The control button 102 is arranged to allow a user of the present invention to perform simple control to the alarm station 1, such as initial setup, request for pairing, or deactivating the alarm device 30 (i.e. snoozing).

The mobile control device 2 is used for controlling and monitoring the operation of the alarm station 1. As shown in FIG. 1 of the drawings, the alarm station 1 and the corresponding mobile control device 2 are arranged to wirelessly pair with each other so as to establish a secured and stable wireless connection. When pairing is successful, the mobile control device 2 is capable of controlling and monitoring the corresponding alarm station 1.

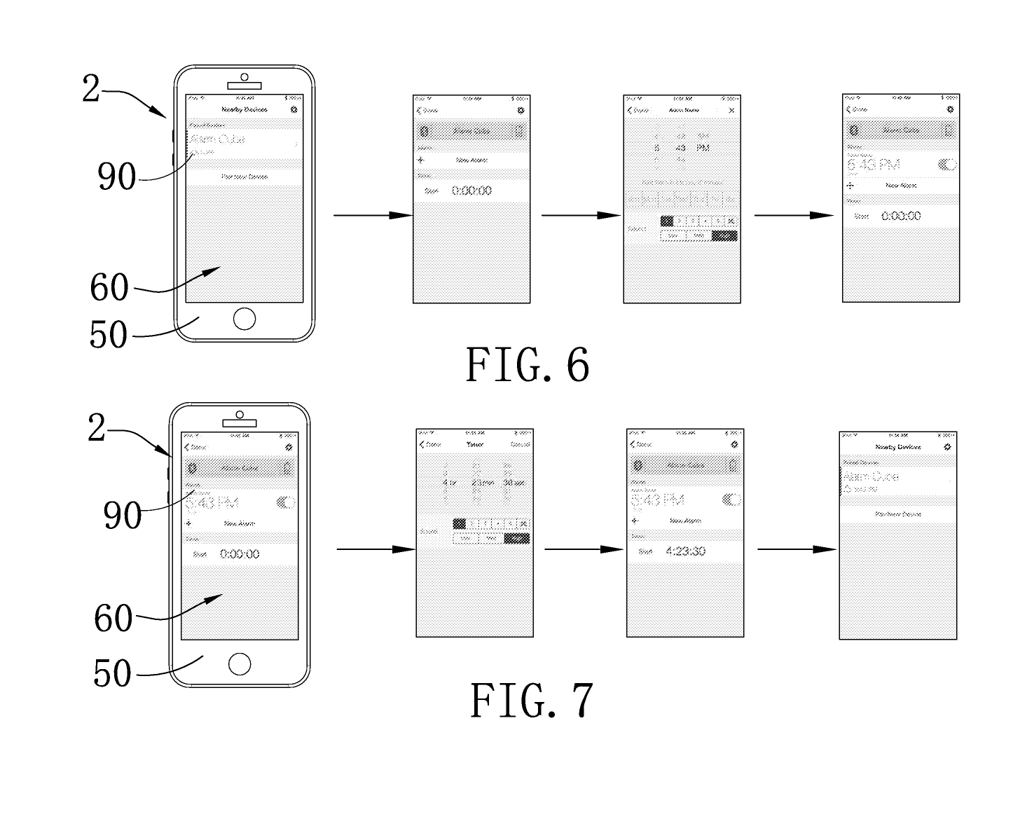

As shown in FIG. 6 and FIG. 7 of the drawings, the mobile control device 2 further comprises an interactive display 90 for allowing a user to visually monitoring the operation of the alarm station 1. The interactive display 90 is electrically connected to the second processing module 80, which may be configured or programmed to set up an alarm time, a current time, a count up or count down timer, and user's preferences in the alarm station 1. The signals or commands which controls or modify the alarm time, the current time, the timer and the user's preference are wirelessly sent to the alarm station 1 from the second wireless transceiver 70 and are received by the first wireless transceiver 20. As mentioned earlier, the wireless signals are transmitted by BLUETOOTH 4.0 wireless technology. The pairing process may be initiated by depressing the control button 102 and indicated by the illuminating device 101 provided on top surface 14 of the alarm casing 10. The illuminating device 101 may generate light of different colors for signaling different operation statuses of the alarm station 1.

When the current time meets the alarm time which has been set up through the mobile control device 2, the second processing module 80 is arranged to drive the alarm device 31 to deliver an alarm signal, such as audible alarm sound.

It is worth mentioning that the mobile control device 2 described above may be incorporated into a smartphone so that the time information or alarm information may be shared with the alarm station 1. For example, the mobile control device 2 may acquire current time from a predetermined telecommunication network or internet and the current time information may be transmitted to the mobile station 1 through the first wireless transceiver 20 and the second wireless transceiver 70. The same can be said for alarm and timer setting. The mobile control device 2 may set up a number of alarms or timers on the alarm station 1.

Furthermore, a single mobile control device 2 may simultaneously control a plurality of alarm stations 1. When a plurality of alarm stations 1 are paired with the mobile control device 2, a central administrator may control the alarm time or timer setting for each of the alarm stations 1.

As shown in FIG. 6 to FIG. 7 of the drawings, in order to set an alarm or timer on the corresponding alarm station 1, an interactive screen is generated on the interactive display 90 of the mobile control device 2. The user will be prompted to enter an alarm information (FIG. 6) or a timer setting (FIG. 7) through operation on the control panel 60. The control panel 60 may be physically provided on the mobile control device 2 a keypad (as shown in FIG. 1). Alternatively, it can also be a virtual keypad generated on the interactive display 90 (as shown in FIG. 6 and FIG. 7). The interactive display 90 may have a touchscreen for allowing a user to input the necessary alarm setting or timer setting. The alarm setting or the timer setting may then be wirelessly transmitted to the alarm station 1 through the first wireless transceiver 20 and the second wireless transceiver 70 in the manner described above. FIG. 6 illustrates the interactive screen shown to the user by the interactive display 90 for setting up an alarm in the alarm station 1. FIG. 7 illustrates the interactive screen shown to the user by the interactive display 90 for setting up a timer in the alarm station 1.

FIG. 8A to FIG. 8E illustrate the circuit diagrams of the wireless alarm system according to the preferred embodiment of the present invention.

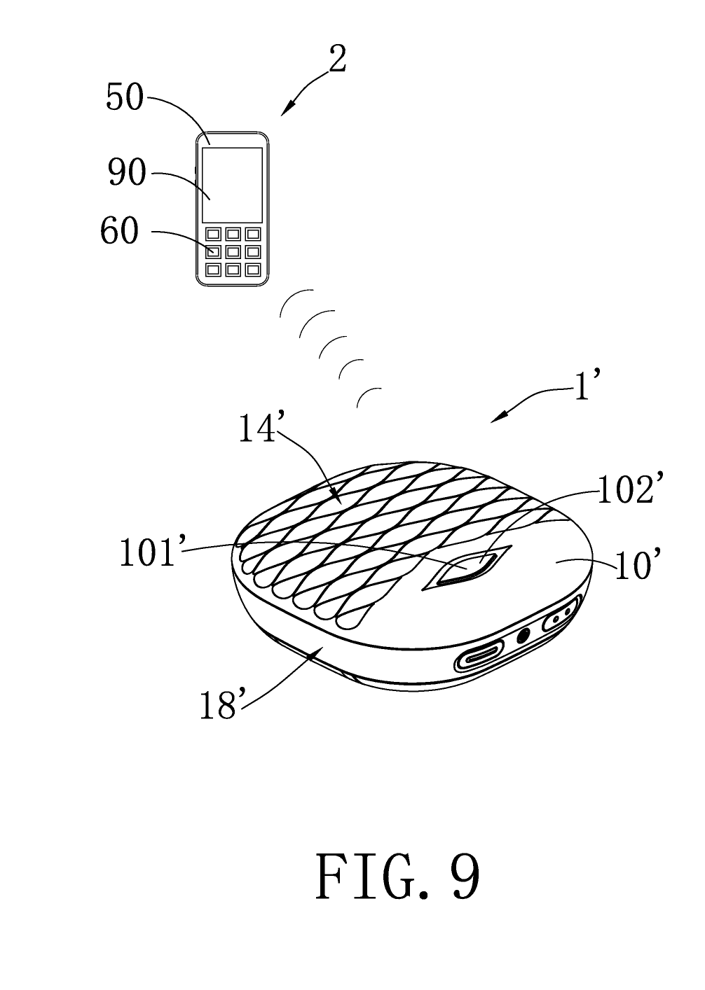

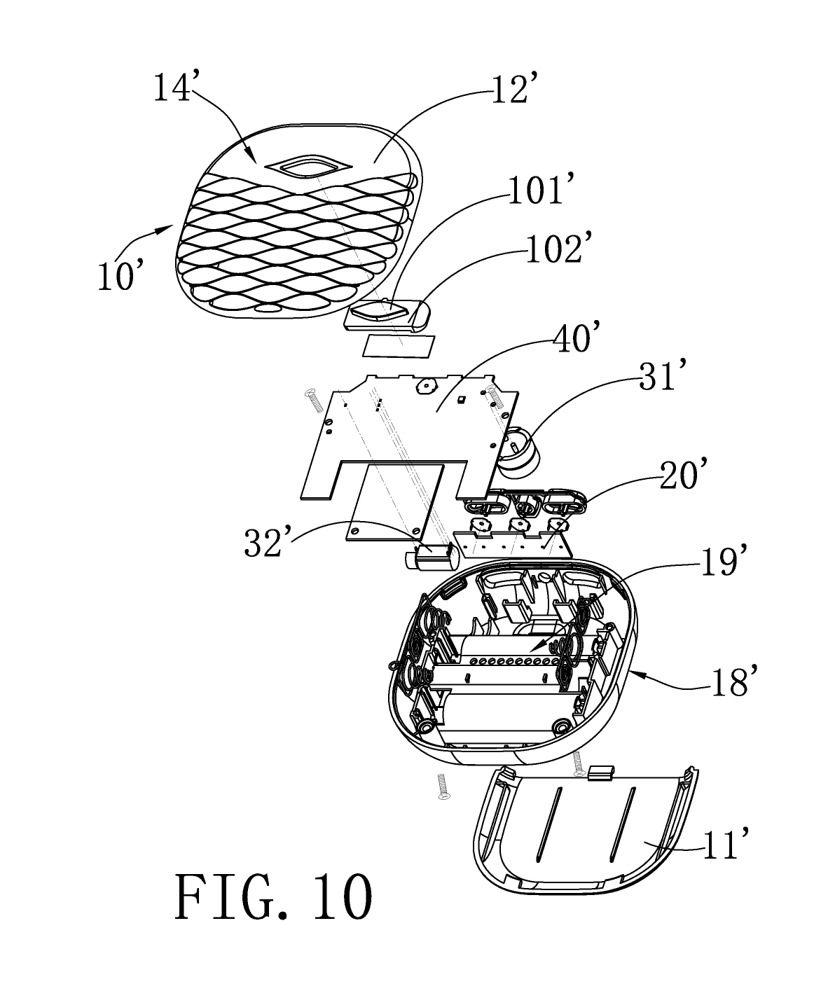

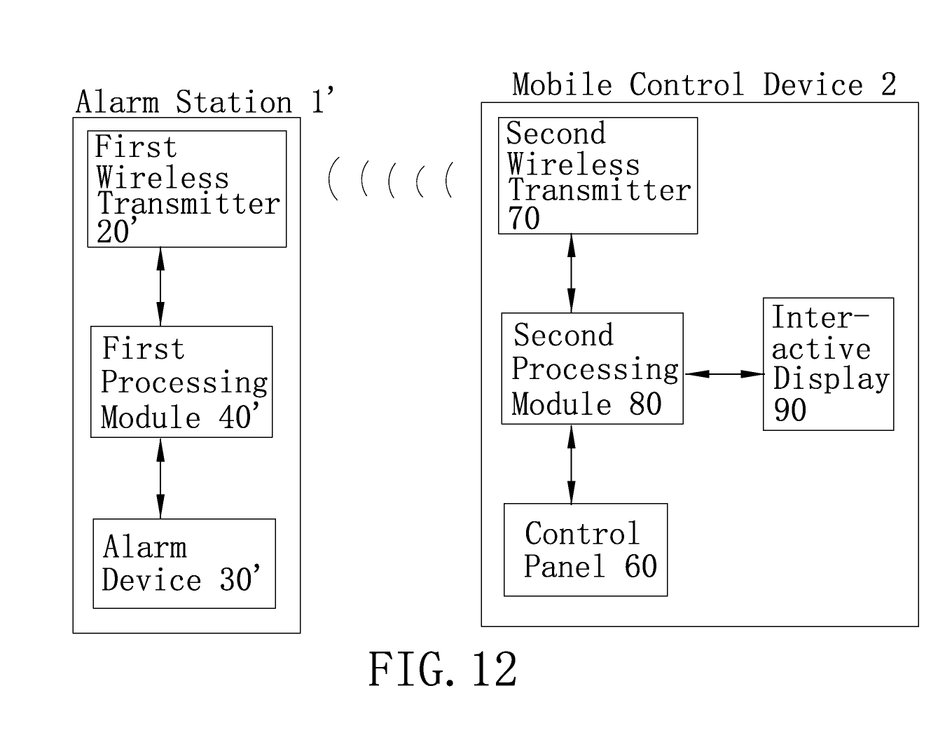

Referring to FIG. 9 to FIG. 15 and FIG. 16A to FIG. 16D of the drawings, a first alternative mode of the wireless alarm system according to the preferred embodiment of the present invention is illustrated. The first alternative mode is similar to the preferred embodiment described above, except the alarm station 1′. The mobile control device 2 in this first alternative mode is structurally identical to the mobile control device 2 disclosed in the first preferred embodiment. The mobile control device 2 is arranged to wirelessly communicate with the alarm station 1′ upon proper pairing.

According to the first alternative mode, the alarm station 1′ comprises an alarm casing 10′, a first wireless transceiver 20′ provided in the alarm casing 10′, an alarm device 30′ supported in the alarm casing 10′, and a first processing module 40′.

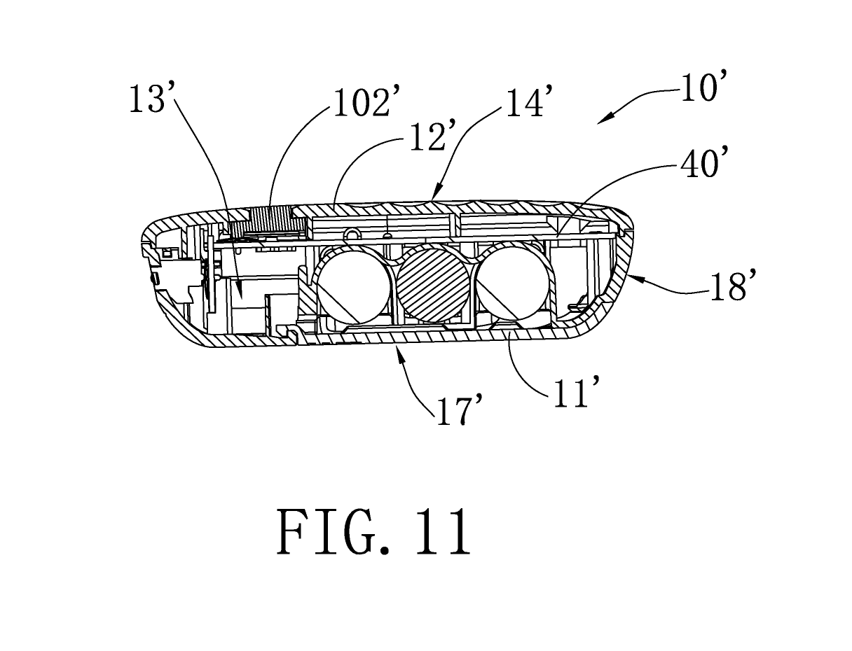

The first processing module 40′ is supported in the alarm casing 10′ and is electrically connected to the first wireless transceiver 20′ and the alarm device 30′. Preferably, the first processing module 40′ is implemented in a Printed Circuit Board (PCB) as shown in FIG. 11 of the drawings.

According to a first alternative mode of the present invention, the alarm casing 10′ is also configured to rest or stand on a flat surface. As shown in FIG. 9 to FIG. 11 of the drawings, the alarm casing 10′ comprises a first casing member 11′ and a second casing member 12′ attached on the first casing member 11′ to define a receiving cavity 13′ in the alarm casing 10′. The alarm casing 10′ has a substantially flat structure having a top surface 14′, a bottom surface 17′ and at least one side surface 18′. Accordingly, a height of the alarm casing 10′ is substantially less than a length and a width thereof so as to constitute the substantially flat structure of the alarm casing 10′, as shown in FIG. 9 of the drawings.

Furthermore, the alarm casing 10′ further has a battery compartment 19′ for accommodating a predetermined number of batteries. The batteries can be typical AA or AAA sized batteries, and they may be rechargeable. The batteries supply power to other parts of the alarm station 1, such as the first wireless transceiver 20′, the alarm device 30′ and the first processing module 40′.

The first wireless transceiver 20′ is supported in the receiving cavity 13′ for wirelessly connecting with the second wireless transceiver 70 of the mobile control device 2. In this first alternative mode, the wireless communication between the first wireless transceiver 20′ and the second wireless transceiver 70 may also be accomplished by BLUETOOTH 4.0 low energy connectivity technology. Thus, the first wireless transceiver 20′ and the second wireless transceiver 70 are preferably BLUETOOTH communication modules.

The alarm device 30′ comprises a speaker unit 31′ supported in the receiving cavity 13′ for generating audible signals as alarm signals, and a vibration generator 32′ supported in the receiving cavity 13′. The vibration generator 32′ is utilized for generating a predetermined amount of vibration on the alarm station 1′ so that it creates a vibration alarm for the user of the present invention.

The first processing module 40′ controls the operation of other components of the alarm station 1′, and processes the signals or commands received from the first wireless transceiver 20′. The time at which the alarm is triggered or activated is controlled and set by the mobile control device 2, as mentioned in the first preferred embodiment above.

The alarm station 1′ further comprises an illuminating device 101′ and a control button 102′ provided on the alarm casing 10′, and are electrically connected to the first processing module 40′. The illuminating device 101′ is arranged to generate illumination of different colors for indicating different operation statuses of the alarm station 1′. The control button 102′ is arranged to allow a user of the present invention to perform simple control to the alarm station 1′, such as initial setup, request for pairing, or deactivating the alarm device 30′ (i.e. snoozing).

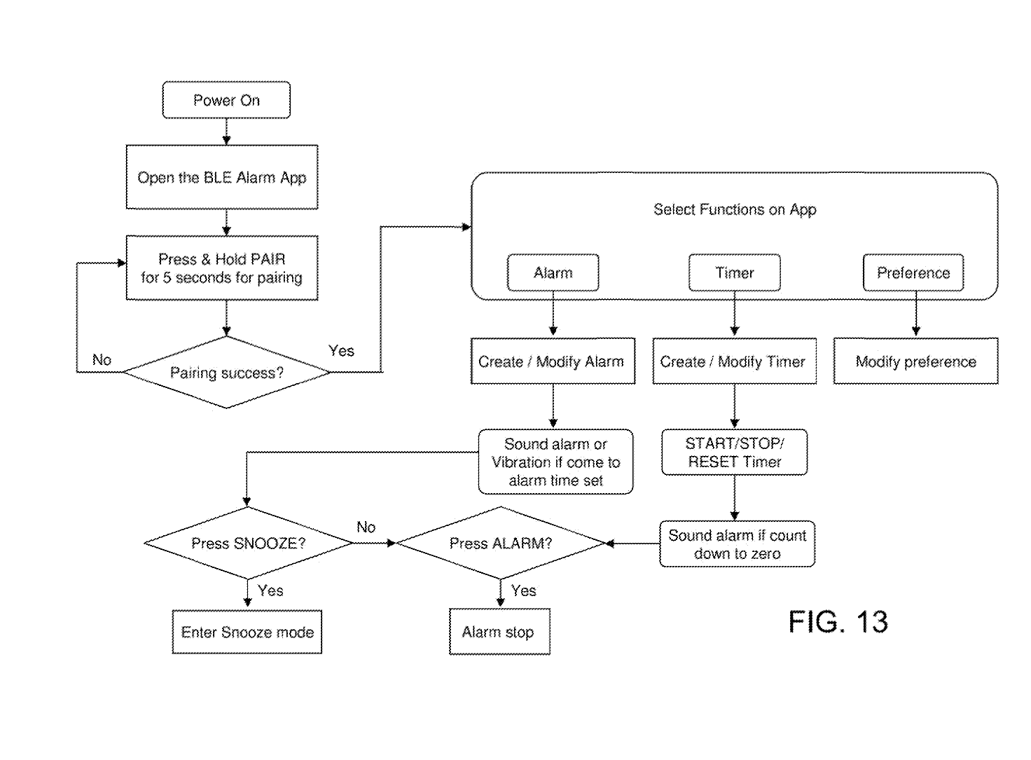

When the current time meets the alarm time which has been set up through the mobile control device 2, the first processing module 40′ is arranged to drive the alarm device 30′ to deliver an alarm signal, such as audible alarm sound. In this second alternative mode, a vibration alarm signal is selectively generated by the vibration generator 32′, as indicated in FIG. 13 of the drawings.

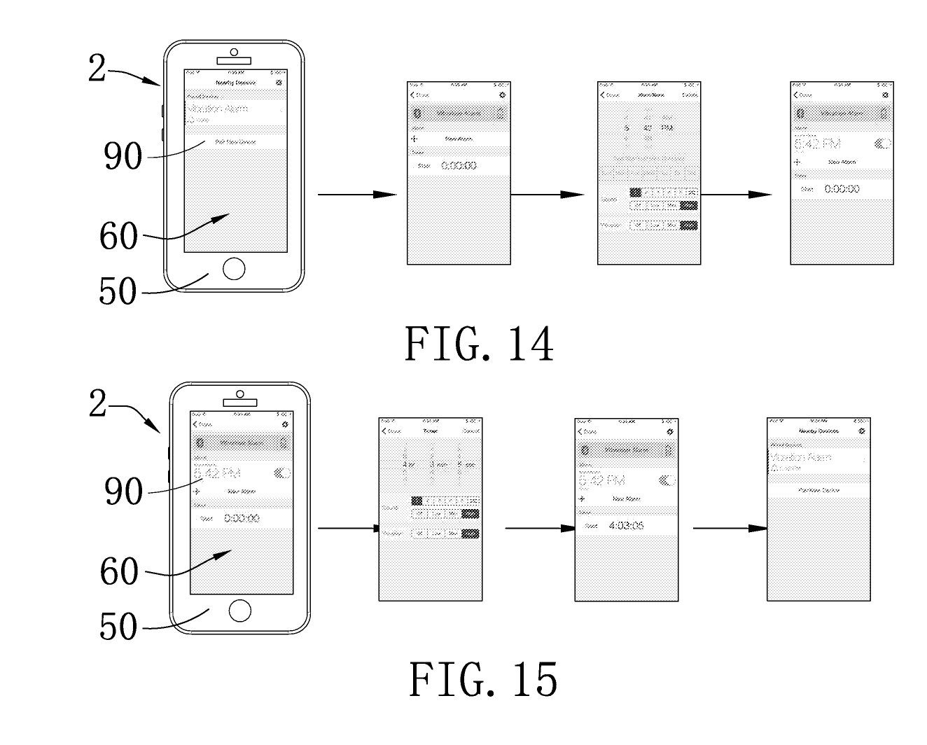

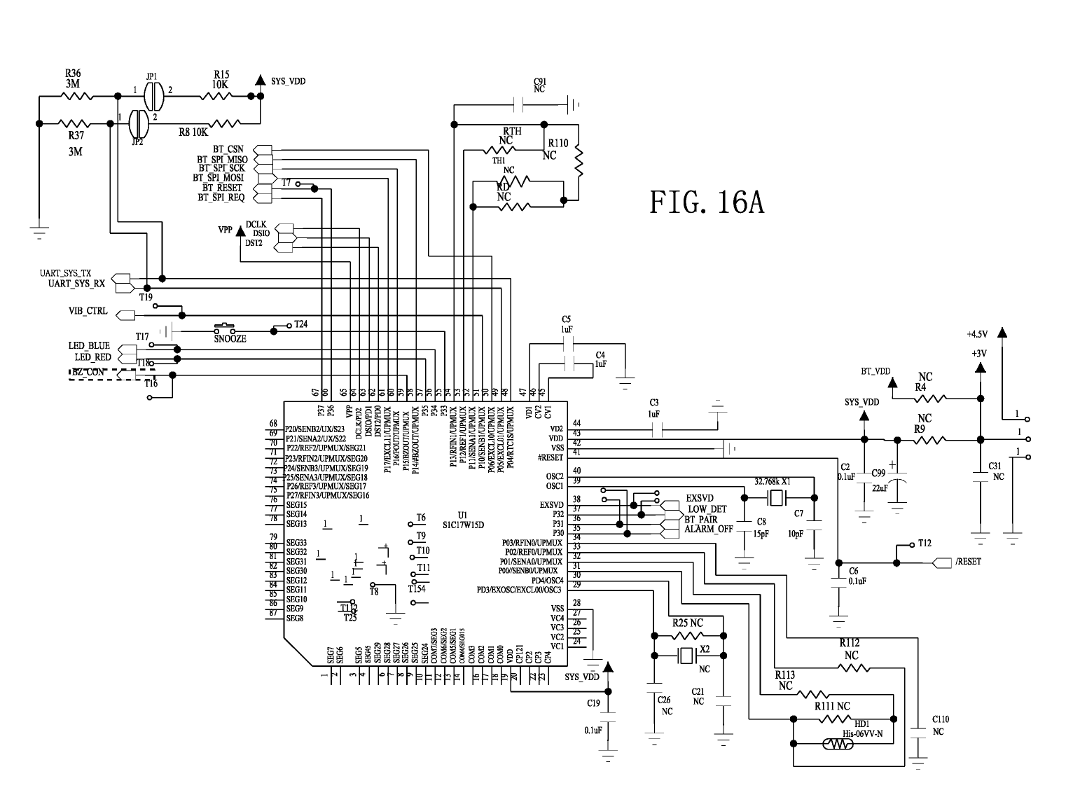

As shown in FIG. 14 to FIG. 15 of the drawings, in order to set an alarm or timer on the corresponding alarm station 1′, an interactive screen is generated on the interactive display 90 of the mobile control device 2. The user will be prompted to enter an alarm information (FIG. 14) or a timer setting (FIG. 15) through operation on the control panel 60. As described in the above preferred embodiment, the alarm setting or the timer setting may then be wirelessly transmitted to the alarm station 1′ through the first wireless transceiver 20′ and the second wireless transceiver 70.

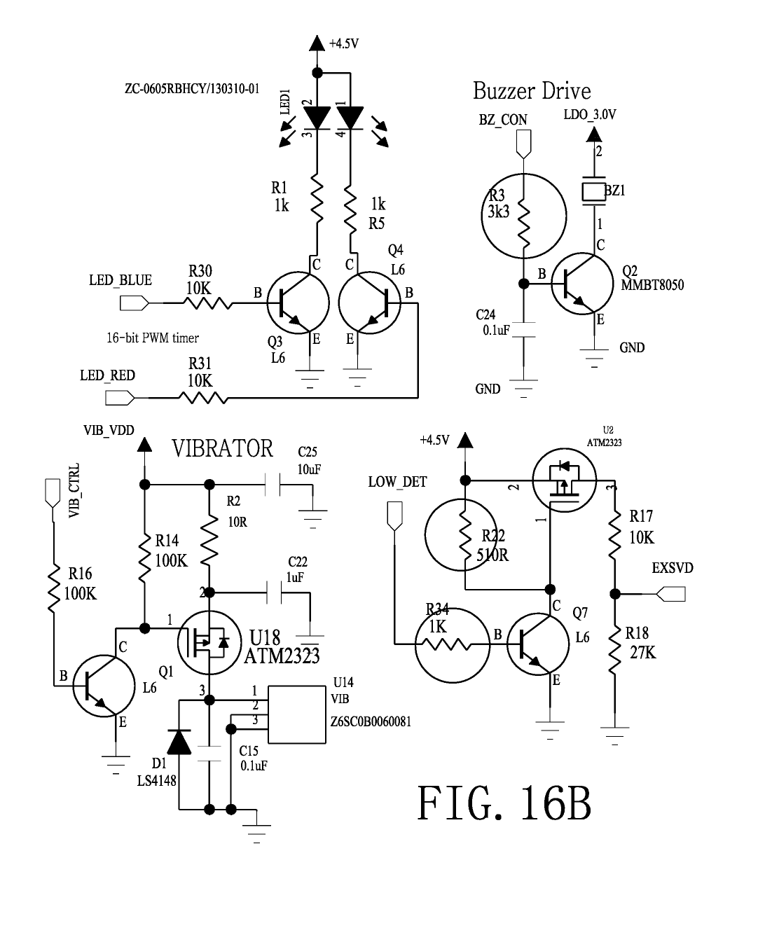

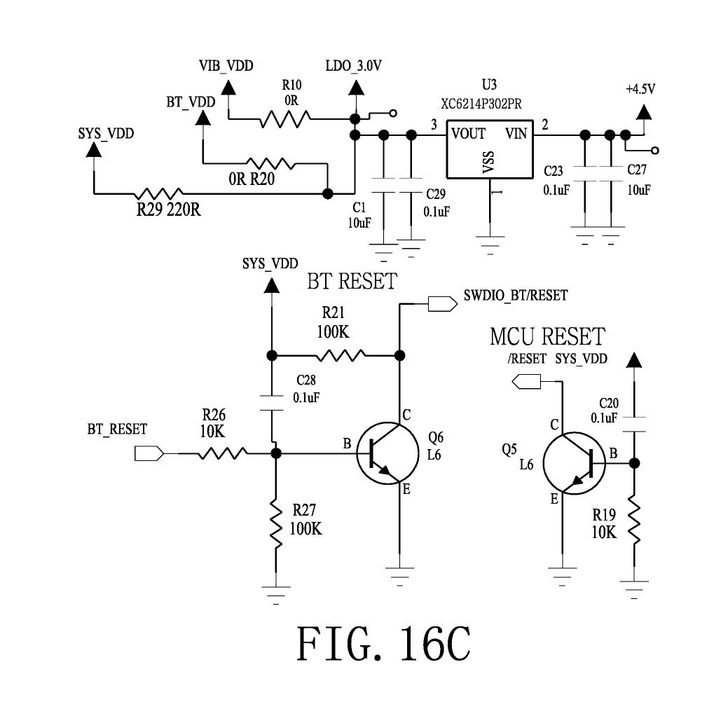

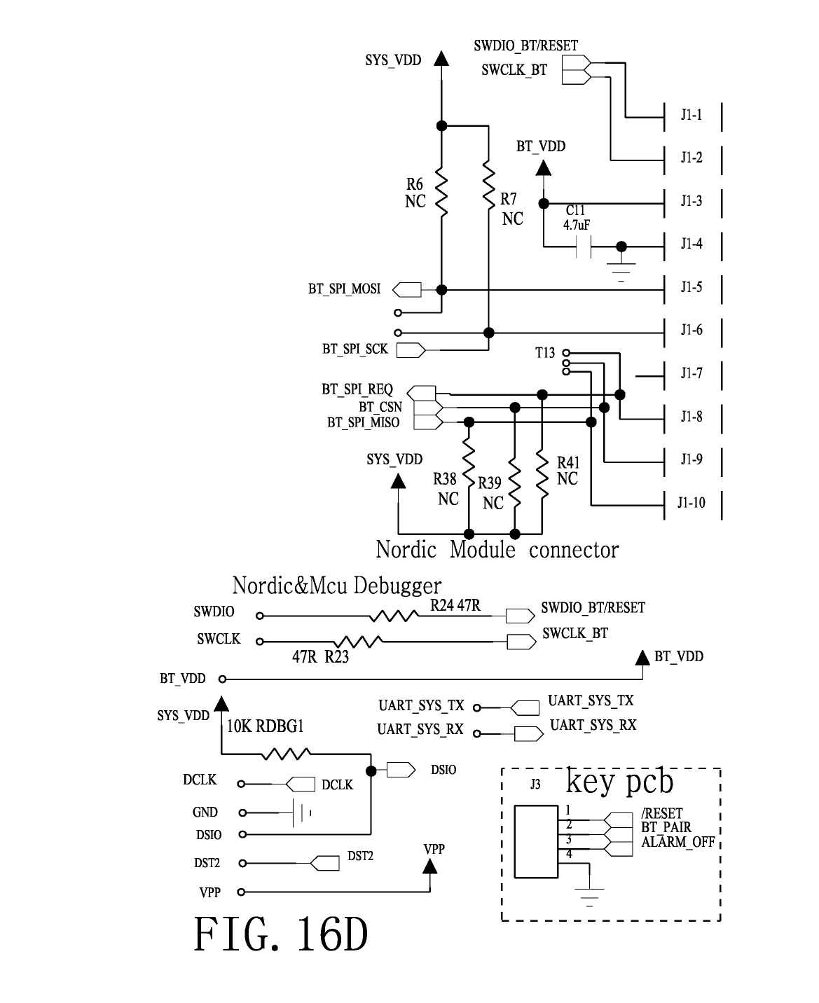

FIG. 16A to FIG. 16D illustrate the circuit diagrams of the wireless alarm system according to the preferred embodiment of the present invention.

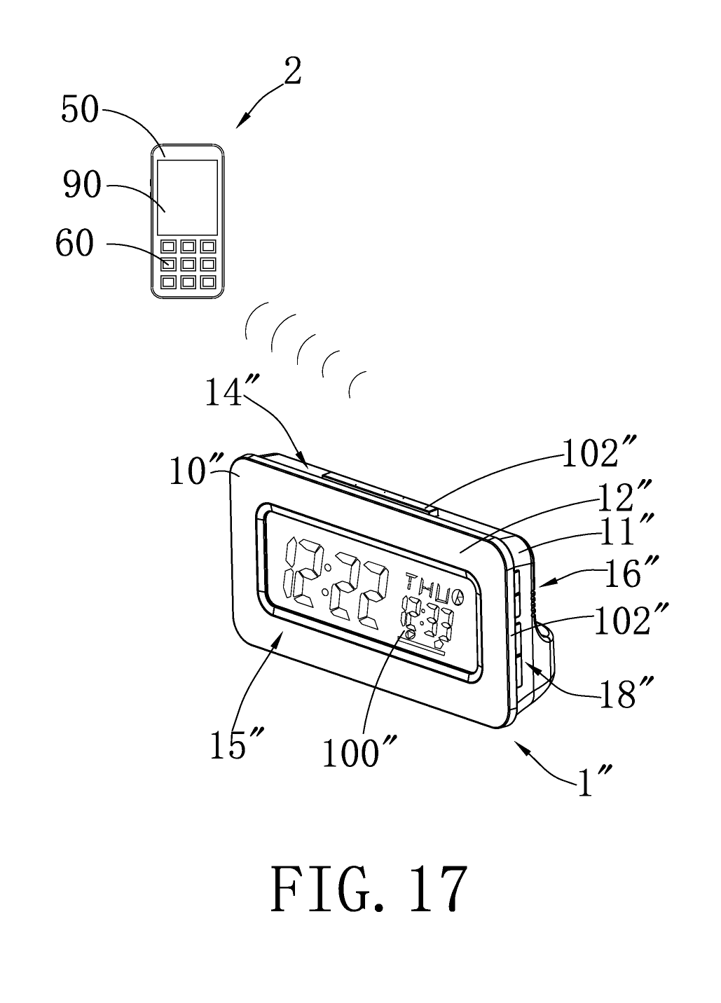

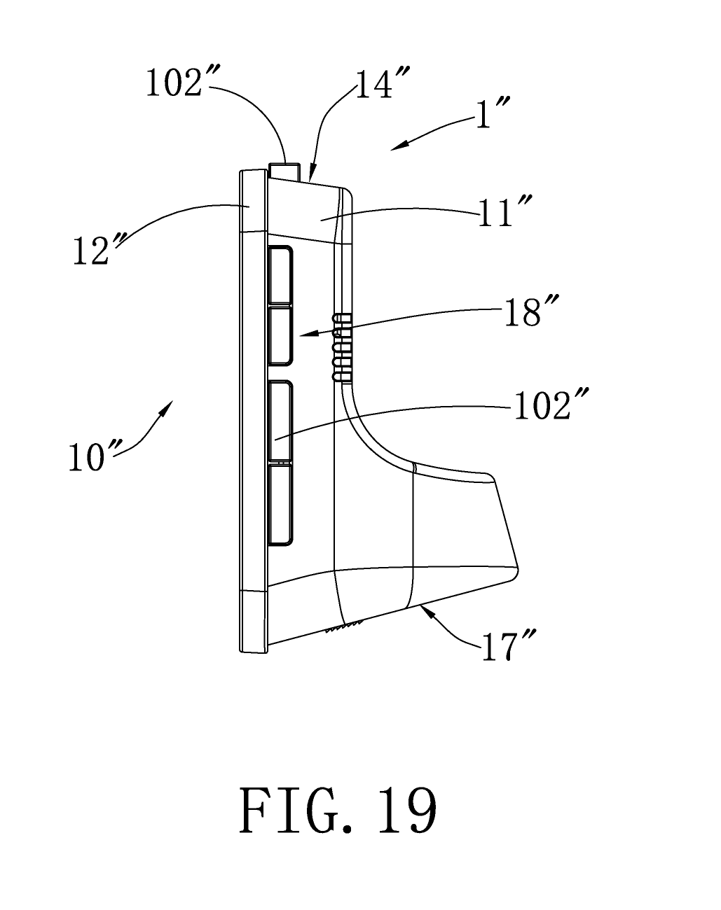

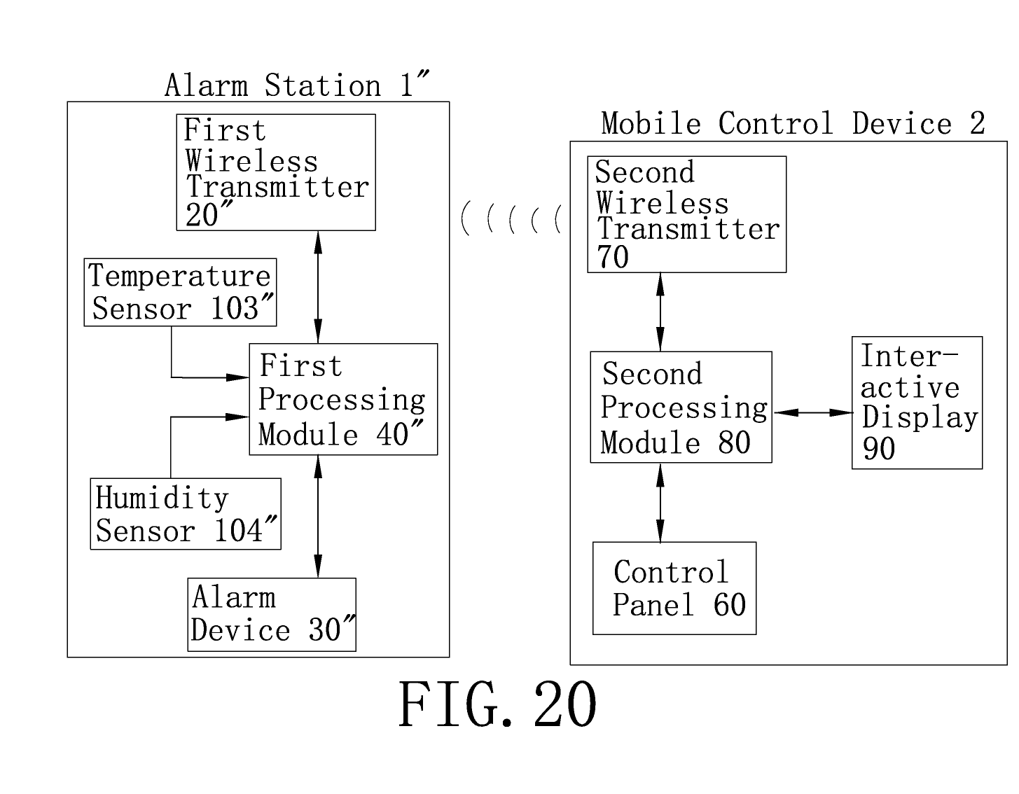

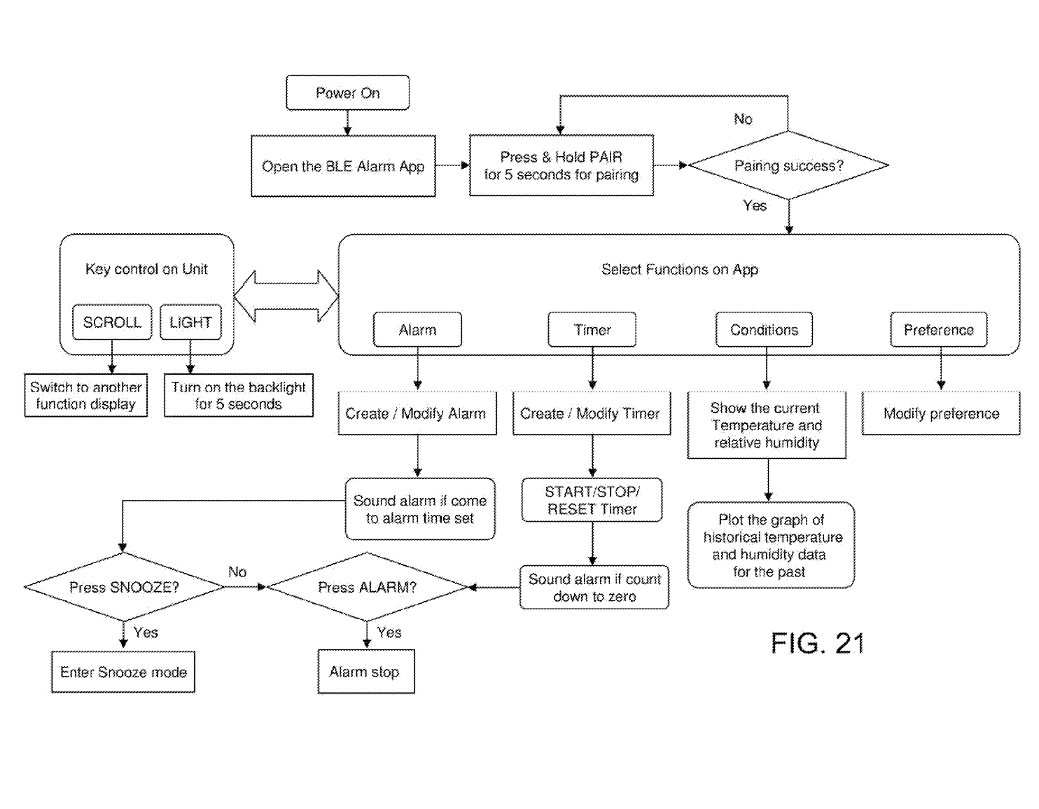

Referring to FIG. 17 to FIG. 24 and FIG. 25A to FIG. 25C of the drawings, a second alternative mode of the wireless alarm system according to a first preferred embodiment of the present invention is illustrated. The second alternative mode is similar to the first preferred embodiment described above, except the alarm station 1″. The mobile control device 2 in this second alternative mode is structurally identical to the mobile control device 2 disclosed in the first preferred embodiment. The mobile control device 2 is arranged to wirelessly communicate with the alarm station 1″ upon proper pairing.

According to the second alternative mode, the alarm station 1″ comprises an alarm casing 10″, a first wireless transceiver 20″ provided in the alarm casing 10″, an alarm device 30″ supported in the alarm casing 10″, a first processing module 40″, and a display unit 100″.

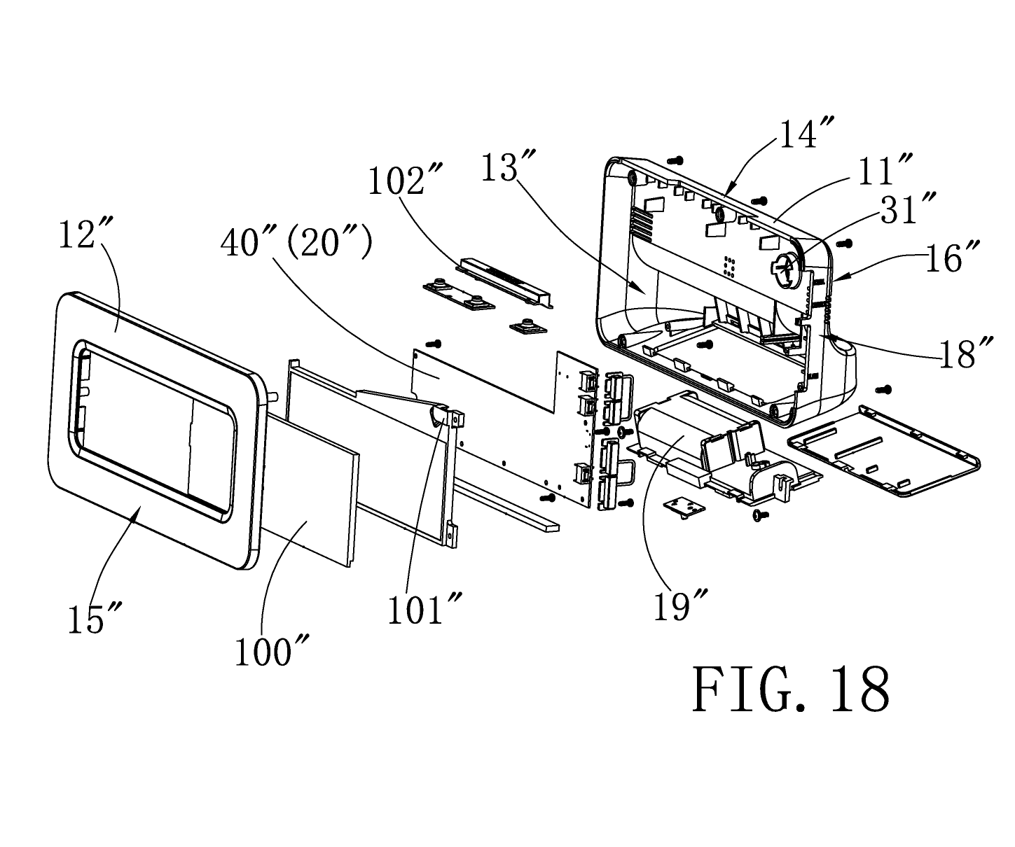

The first processing module 40″ is supported in the alarm casing 10″ and is electrically connected to the first wireless transceiver 20″ and the alarm device 30″. Preferably, the first processing module 40″ is implemented in a Printed Circuit Board (PCB) as shown in FIG. 18 of the drawings.

According to a second alternative mode of the present invention, the alarm casing 10″ is also configured to rest or stand on a flat surface (FIG. 17). As shown in FIG. 17 and FIG. 18 of the drawings, the alarm casing 10″ comprises a first casing member 11″ and a second casing member 12″ attached on the first casing member 11″ to define a receiving cavity 13″ in the alarm casing 10″. The alarm casing 10″ has a top surface 14″, a front surface 15″, a rear surface 16″, a bottom surface 17″ and two side surfaces 18″. In this second alternative mode, the areas of the front surface 15″ and the rear surface 16″ are substantially larger than that of the top surface 14″ and the bottom surface 17″. The display unit 100″ is mounted on the front surface 15″ of the alarm casing 10″ for displaying time or other weather information. In this second alternative mode, the bottom surface 17″ is a flat surface and may be inclined so as to allow the alarm station 1″ to optimally stand on a flat surface, such as a desk surface.

Furthermore, the alarm casing 10″ further has a battery compartment 19″ for accommodating a predetermined number of batteries. The batteries can be typical AA or AAA sized batteries, and they may be rechargeable. The batteries supply power to other parts of the alarm station 1″, such as the first wireless transceiver 20″, the alarm device 30″ and the first processing module 40″.

The first wireless transceiver 20″ is also supported in the receiving cavity 13″ for wirelessly connecting with the second wireless transceiver 70 of the mobile control device 2. In the second alternative mode, the wireless communication between the first wireless transceiver 20″ and the second wireless transceiver 70 is also accomplished by BLUETOOTH 4.0 low energy connectivity technology. Accordingly, the first wireless transceiver 20″ and the second wireless transceiver 70 are preferably BLUETOOTH communication modules. Moreover, the first wireless transceiver 20″ and the first processing module 40″ may be implemented in a single Printed Circuit Board (PCB), as shown in FIG. 16 of the drawings.

The alarm device 30″ comprises a speaker unit 31″ supported in the receiving cavity 13″ for generating audible signals as alarm signals.

The first processing module 40″ controls the operation of other components of the alarm station 1″, and processes the signals or commands received from the first wireless transceiver 20″. The time at which the alarm is triggered or activated is controlled and set by the mobile control device 2, as mentioned in the first preferred embodiment above. Moreover, the first processing module 40″ may be programmed or configured to deliver a plurality of audible alarm patterns through the alarm device 30″. For example, a number of sound patterns or songs may be available for user's selection.

The alarm station 1″ further comprises an illuminating device 101″ and a control button 102″ provided on the alarm casing 10″, and are electrically connected to the first processing module 40″. The illuminating device 101″ may be arranged to provide illumination to the display unit 100″ which displays different operation statuses of the alarm station 1″. The control button 102″ is arranged to allow a user of the present invention to perform simple control to the alarm station 1″, such as initial setup, request for pairing, or deactivating the alarm device 30″ (i.e. snoozing).

According to the second alternative mode, the alarm station 1″ further comprises a temperature sensor 103″ and a humidity sensor 104″ provided on the alarm station 1″ for detecting an indoor temperature and humidity of the environment in which the alarm station 1″ is placed. The temperature and humidity information may be displayed by the display unit 100″ of the alarm station 1″. More importantly, the temperature and humidity information may also be wirelessly transmitted to the mobile control device 2 so that a user may be able to get the relevant information from the mobile control device 2 through the interactive display 90.

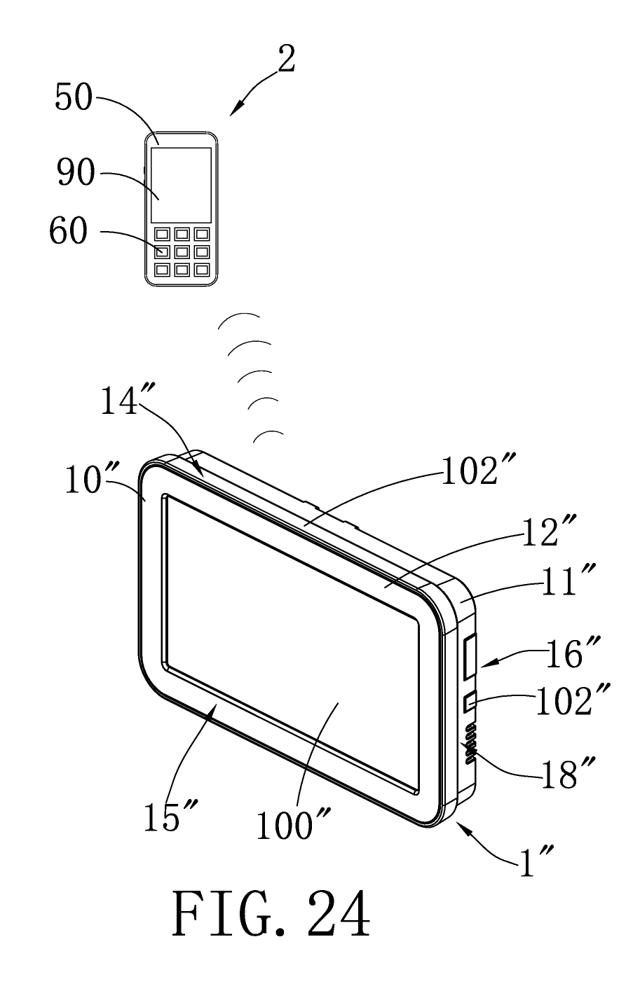

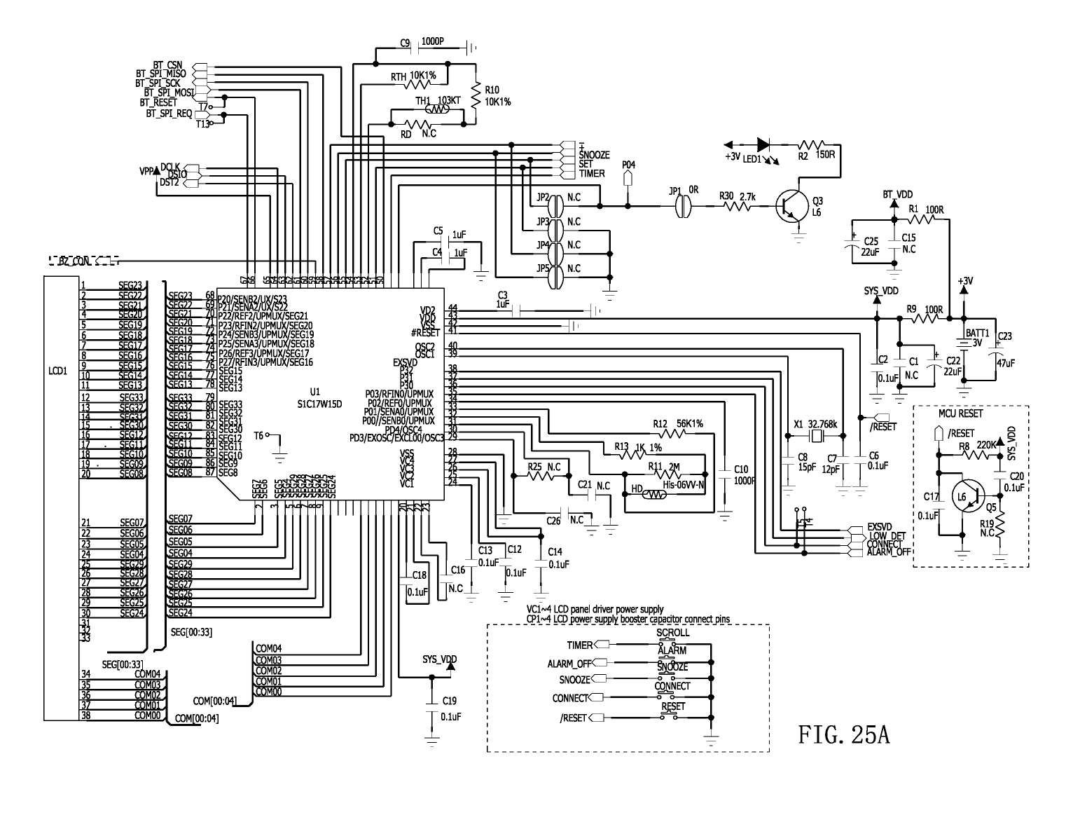

It is worth mentioning that the alarm station 1″ of the second alternative mode may be configured to stand on a flat surface (FIG. 17), such as a desk surface, or to be hung on a wall (FIG. 24). In the latter case, the alarm station 1″ may be embodied as a wall clock and the rear surface 16″ of the alarm casing 10″ is a flat surface which allows the alarm station 1″ to be conveniently hung on a wall, as shown in FIG. 24 of the drawings.

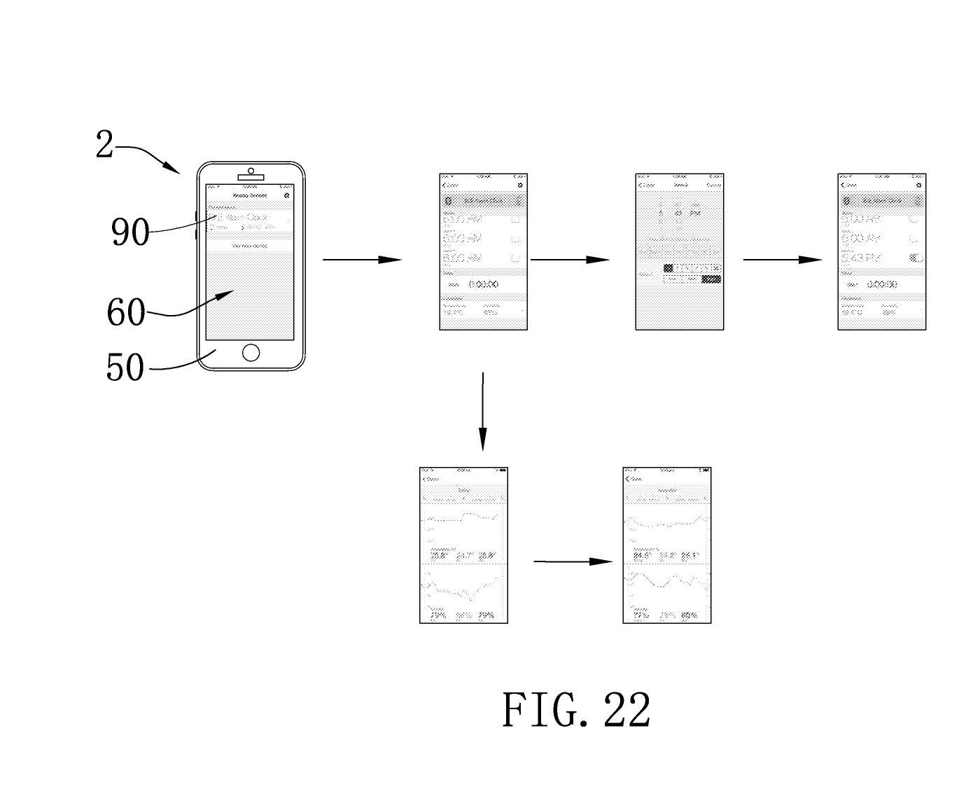

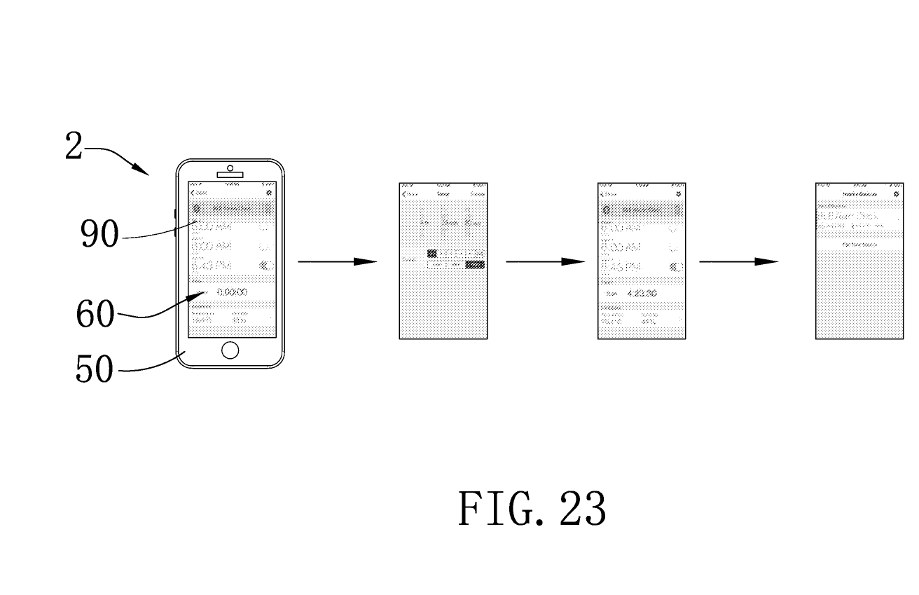

As shown in FIG. 22 to FIG. 23 of the drawings, in order to set an alarm or timer on the corresponding alarm station 1′, an interactive screen is generated on the interactive display 90 of the mobile control device 2. The user will be prompted to enter an alarm setting (FIG. 22) or a timer setting (FIG. 23) through operation on the control panel 60. In the second alternative mode, the mobile control device 2 may also allow the user to monitor the temperature and humidity of the indoor space in which the corresponding alarm station 1″ is located. This is also shown in FIG. 22.

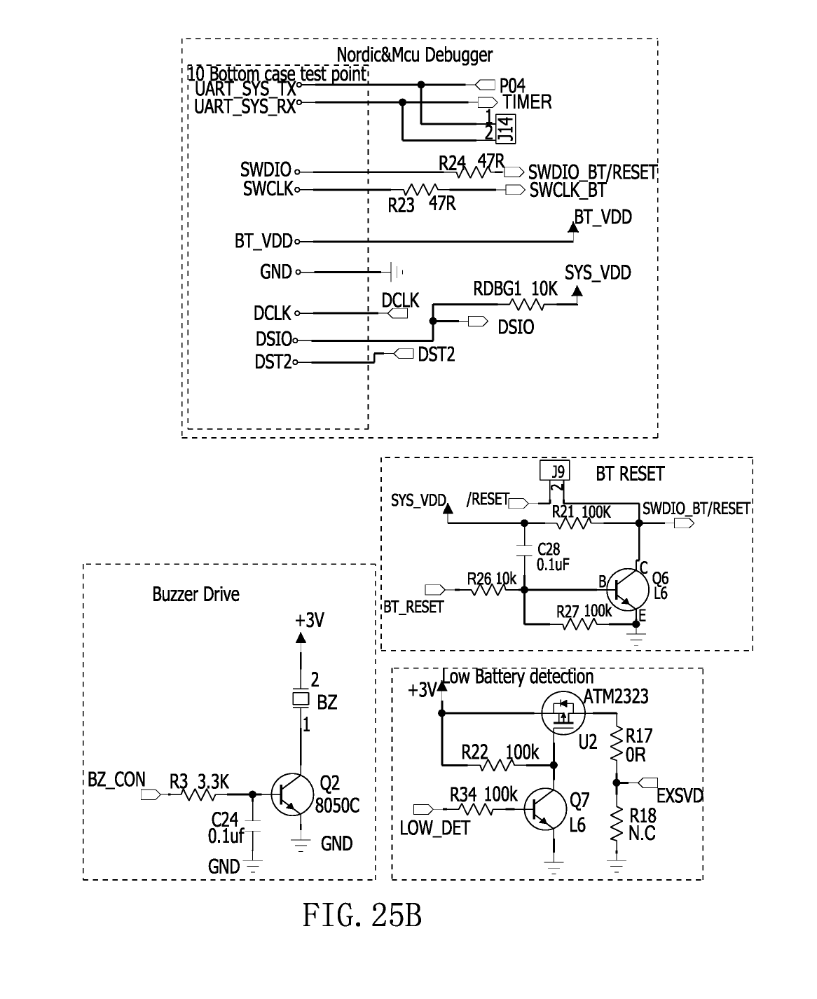

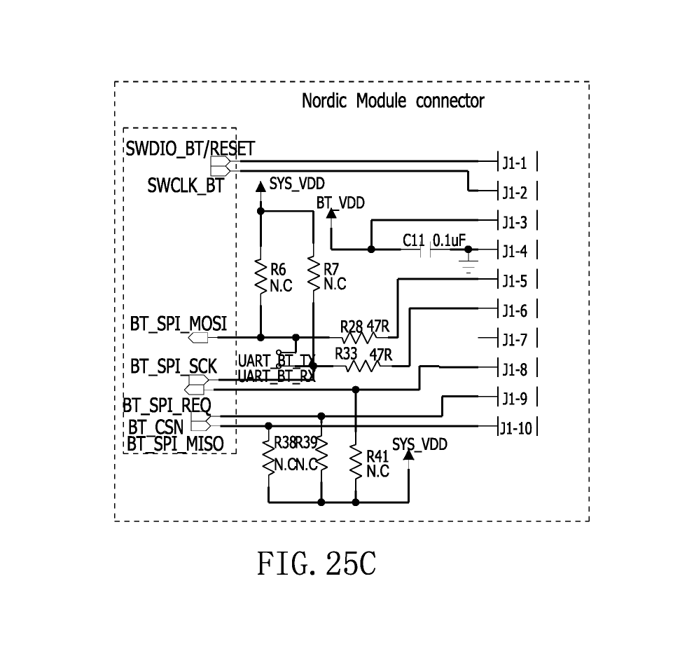

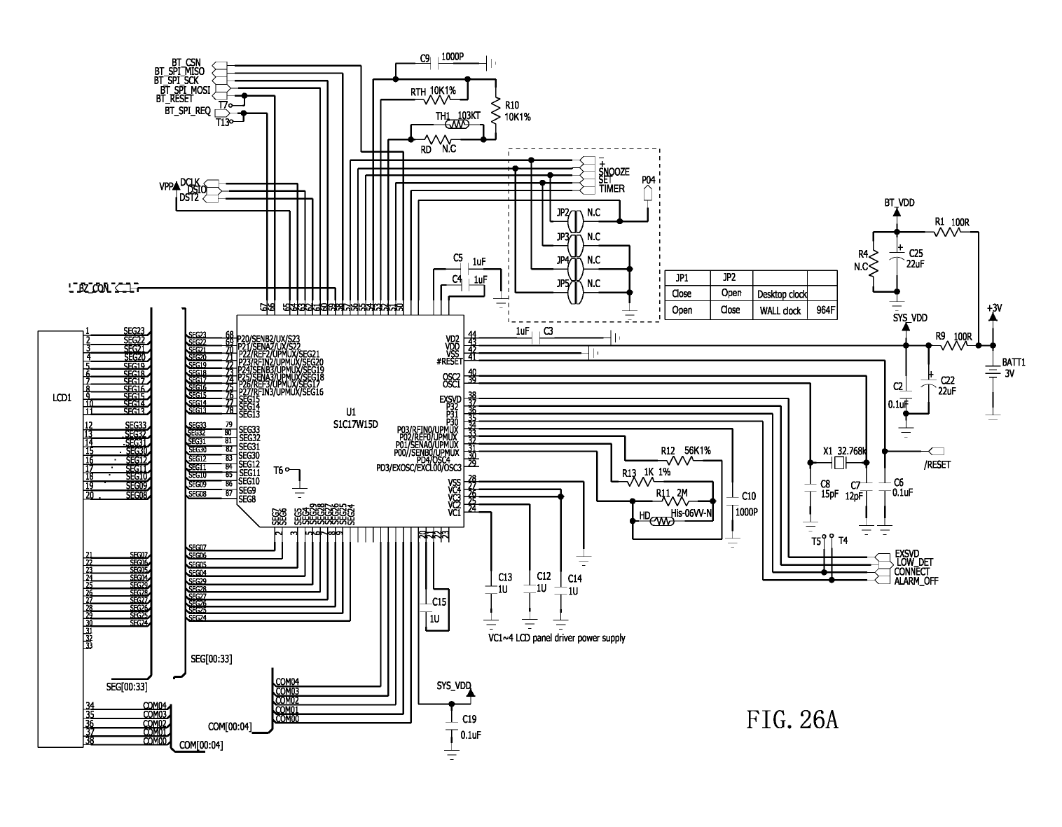

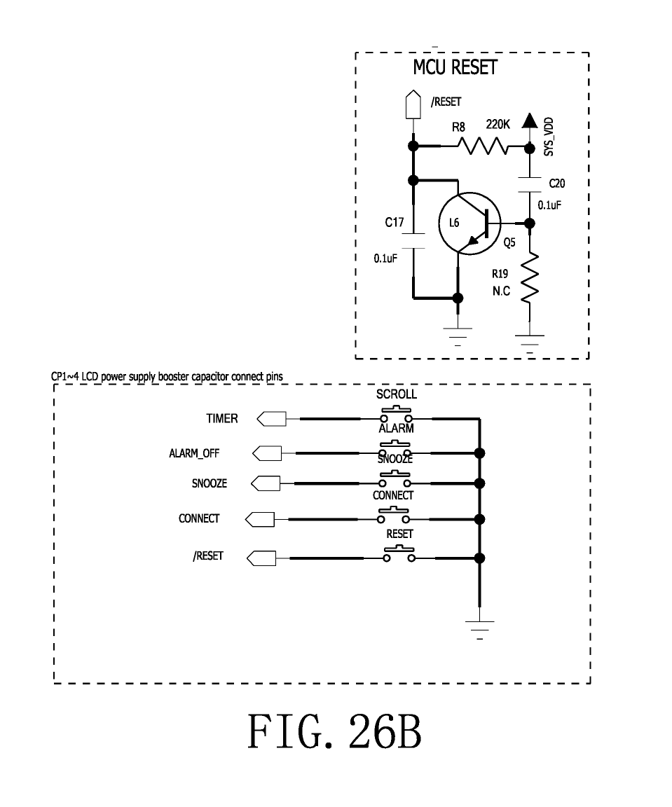

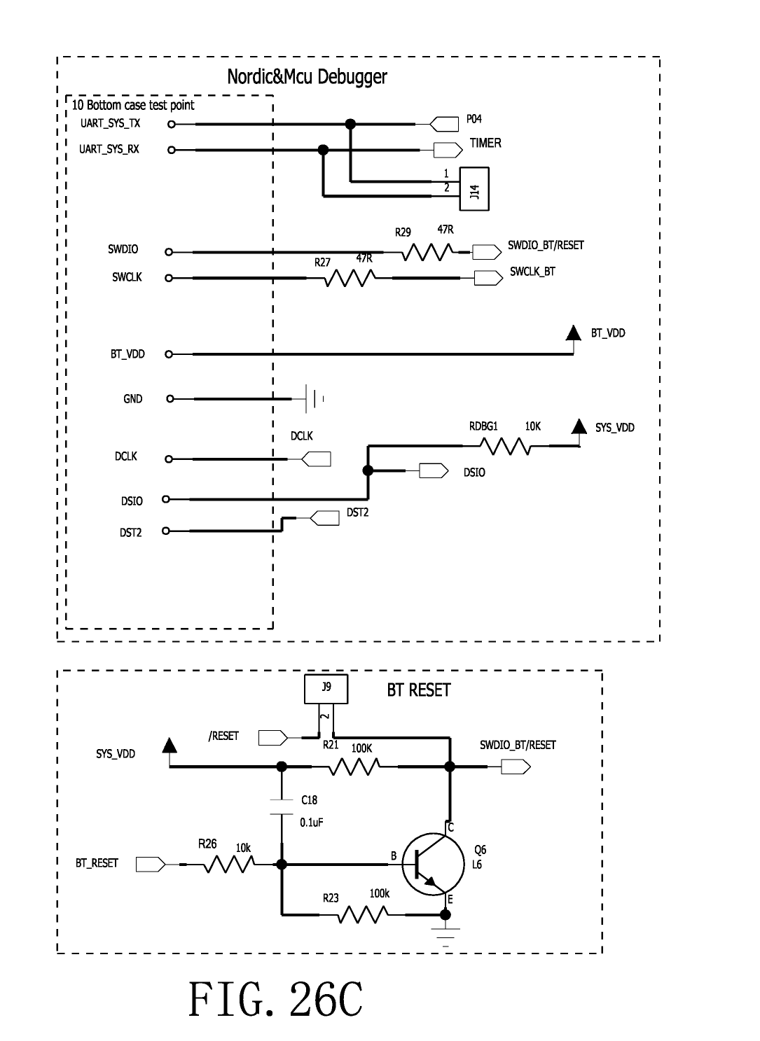

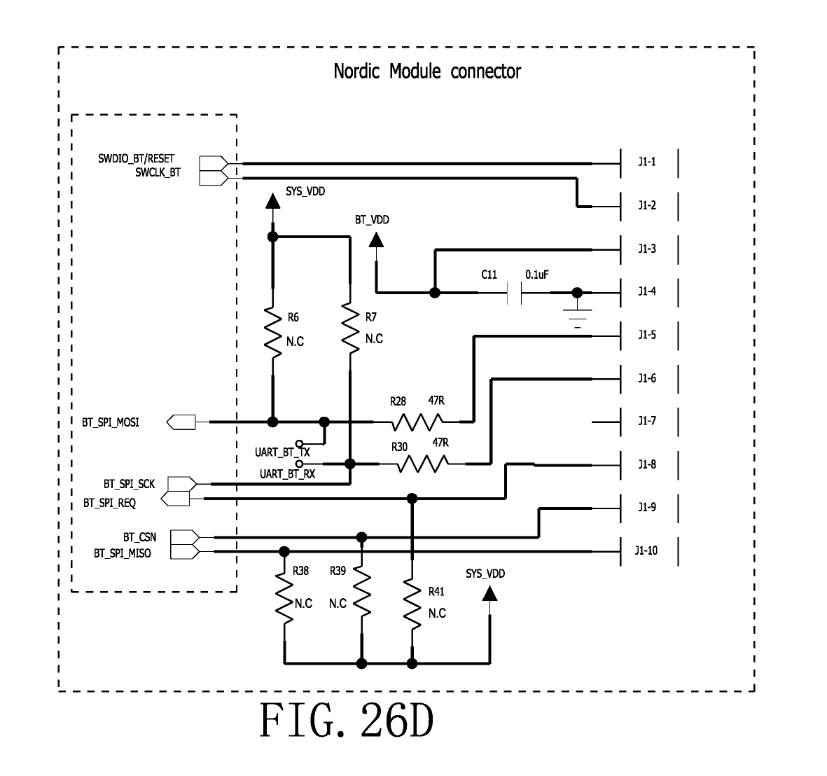

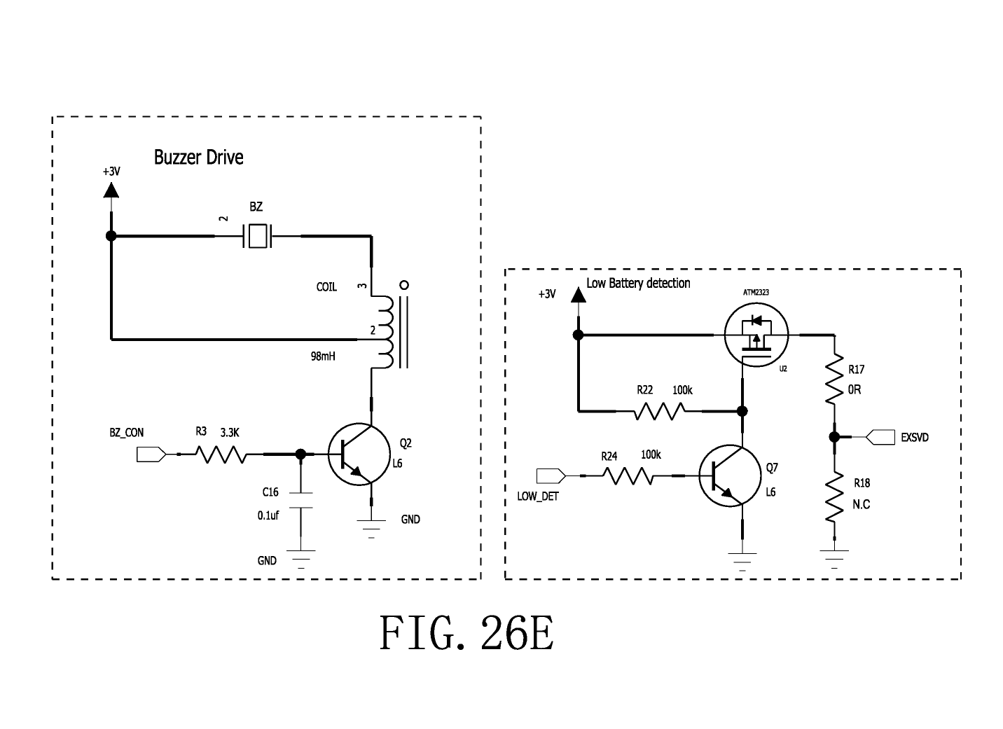

FIG. 25A to FIG. 25C illustrate the circuit diagrams of the wireless alarm system according to the second alternative mode of the preferred embodiment of the present invention. FIG. 26A to FIG. 26E illustrate the circuit diagrams of the wireless alarm system according to the second alternative mode of the preferred embodiment of the present invention. The wireless alarm system is to be mounted on a wall.

It is important to mention that the various patentable features or components of the present invention may be switched between different the alternative modes and these combination of features fall within the spirit of the present invention. For example, the display unit 100″ described in the second alternative mode may be implemented in the first alternative mode so that the alarm station 1′ disclosed in the first alternative mode may also have a display unit. The exact combination and configuration of the various components disclosed above depend on the actual circumstances in which the present invention is manufactured and marketed.

The present invention, while illustrated and described in terms of a preferred embodiment and several alternatives, is not limited to the particular description contained in this specification. Additional alternative or equivalent components could also be used to practice the present invention.

What is claimed is:

1. A wireless alarm system, comprising:
at least one alarm station, which comprises:
an alarm casing;
a first wireless transceiver provided in said alarm casing;
an alarm device;
a first processing module supported in said alarm casing and electrically connected to said first wireless transceiver and said alarm device; and
a mobile control device which is connected to internet, and comprises:
a mobile device casing;
a control panel supported on said device casing;
a second wireless transceiver supported by said mobile device casing, and wirelessly communicated with said first wireless transceiver of said alarm station; and
a second processing module supported in said mobile device casing and electrically connected to said control panel, and said second wireless transceiver, said second processing module being configured to communicate with said first processing module via said first wireless transceiver and said second wireless transceiver for setting up an alarm in said alarm station, whereby a user is able to control setting of said alarm in said alarm station by operating on said control panel of said mobile control device.

2. The wireless alarm system, as recited in claim 1, wherein said second processing module is configured to set up at least one of an alarm time, a current time, and a timer for said alarm station.

3. The wireless alarm system, as recited in claim 2, wherein said mobile control device further comprises an interactive display electrically connected to said second processing module for allowing a user to visually monitor and control at least one of said alarm time, said current time and said timer of said alarm station.

4. The wireless alarm system, as recited in claim 3, wherein said second processing module is configured to generate an interactive screen on said interactive display of said mobile control device for allowing a user to perform alarm setup on at least one of said alarm time, said current time, and said timer for said alarm station.

5. The wireless alarm system, as recited in claim 4, wherein each of said first wireless transceiver and said second wireless transceiver is a BLUETOOTH communication module, so that wireless communication between said first wireless transceiver and said second wireless transceiver is through BLUETOOTH 4.0 low energy connectivity technology.

6. The wireless alarm system, as recited in claim 5, wherein said alarm casing comprises a first casing member and a second casing member attached on said first casing member to define a receiving cavity in said alarm casing, said alarm casing having a substantially cubic structure for standing on a flat surface.

7. The wireless alarm system, as recited in claim 5, wherein said alarm device comprises at least one speaker unit supported in said alarm casing.

8. The wireless alarm system, as recited in claim 5, wherein said alarm station further comprises at least one of an illuminating device and a control button provided on said alarm casing, and are electrically connected to said first processing module.

9. The wireless alarm system, as recited in claim 5, wherein said alarm casing comprises a first casing member and a second casing member attached on said first casing member to define a receiving cavity in said alarm casing, a height of said alarm casing being substantially less than a length and a width thereof so as to constitute a substantially flat structure of said alarm casing.

10. The wireless alarm system, as recited in claim 8, wherein said alarm casing comprises a first casing member and a second casing member attached on said first casing member to define a receiving cavity in said alarm casing, a height of said alarm casing being substantially less than a length and a width thereof so as to constitute a substantially flat structure of said alarm casing.

11. The wireless alarm system, as recited in claim 5, wherein said alarm device further comprises a vibration generator supported in said receiving cavity.

12. The wireless alarm system, as recited in claim 10, wherein said alarm device further comprises a vibration generator supported in said receiving cavity.

13. The wireless alarm system, as recited in claim 5, wherein said alarm casing has a top surface, a front surface, a rear surface, a bottom surface and two side surfaces, an area of said front surface being substantially larger than that of said top surface and said bottom surface.

14. The wireless alarm system, as recited in claim 8, wherein said alarm casing has a top surface, a front surface, a rear surface, a bottom surface and two side surfaces, an area of said front surface being substantially larger than that of said top surface and said bottom surface.

15. The wireless alarm system, as recited in claim 13, wherein said alarm station further comprises a display unit provided on a front side thereof.

16. The wireless alarm system, as recited in claim 14, wherein said alarm station further comprises a display unit provided on a front side thereof.

17. The wireless alarm system, as recited in claim 15, wherein said alarm station further comprises at least one of a temperature sensor and a humidity sensor provided on said alarm station for detecting an indoor temperature and humidity of an environment in which said alarm station is placed.

18. The wireless alarm system, as recited in claim 16, wherein said alarm station further comprises at least one of a temperature sensor and a humidity sensor provided on said alarm station for detecting an indoor temperature and humidity of an environment in which said alarm station is placed.

19. The wireless alarm system, as recited in claim 17, wherein said second processing module is configured to generate an interactive screen on said interactive display of said mobile control device for allowing a user to monitor said temperature and said humidity on said interactive screen.

20. The wireless alarm system, as recited in claim 18, wherein said second processing module is configured to generate an interactive screen on said interactive display of said mobile control device for allowing a user to monitor said temperature and said humidity on said interactive screen.

21. An alarm station for use with a mobile control device, comprising:
an alarm casing;
a first wireless transceiver provided in said alarm casing;
an alarm device; and
a first processing module supported in said alarm casing and electrically connected to said first wireless transceiver and said alarm device, said first processing module being configured to receive wireless signals from said mobile control device through said first wireless transceiver, and drive said alarm device to generate an alarm signal in accordance with said signals of said mobile control device, whereby a user is able to control setting of said alarm in said alarm station by operating on said mobile control device.

22. The wireless alarm system, as recited in claim 21, wherein said first wireless transceiver comprises a BLUETOOTH communication module, so that wireless communication between said first wireless transceiver and mobile control device is through BLUETOOTH 4.0 low energy connectivity technology.

23. The wireless alarm system, as recited in claim 22, wherein said alarm casing comprises a first casing member and a second casing member attached on said first casing member to define a receiving cavity in said alarm casing, said alarm casing having a substantially cubic structure for standing on a flat surface.

24. The wireless alarm system, as recited in claim 23, wherein said alarm device comprises at least one speaker unit supported in said alarm casing.

25. The wireless alarm system, as recited in claim 24, wherein said alarm station further comprises at least one of an illuminating device and a control button provided on said alarm casing, and are electrically connected to said first processing module.

26. The wireless alarm system, as recited in claim 22, wherein said alarm casing comprises a first casing member and a second casing member attached on said first casing member to define a receiving cavity in said alarm casing, a height of said alarm casing being substantially less than a length and a width thereof so as to constitute a substantially flat structure of said alarm casing.

27. The wireless alarm system, as recited in claim 26, wherein said alarm device further comprises a vibration generator supported in said receiving cavity.

28. The wireless alarm system, as recited in claim 22, wherein said alarm casing has a top surface, a front surface, a rear surface, a bottom surface and two side surfaces, an area of said front surface being substantially larger than that of said top surface and said bottom surface.

29. The wireless alarm system, as recited in claim 28, wherein said alarm station further comprises a display unit provided on a front side thereof.

30. The wireless alarm system, as recited in claim 29, wherein said alarm station further comprises at least one of a temperature sensor and a humidity sensor provided on said alarm station for detecting an indoor temperature and humidity of an environment in which said alarm station is placed.
